(19) United States
(12) Patent Application Publication
(10) Pub. No.: US 2026/0236801 A1
(43) Pub. Date: Aug. 13, 2026

(54) Inference Output Alignment Using Dimensional Analysis

(71) Applicant: GDM Holding LLC, Mountain View, CA (US)

(72) Inventors: Florian Nils Hartmann, Zurich (CH); Sian Heather Gooding, London (GB)

(21) Appl. No.: 19/052,871

(22) Filed: Feb. 13, 2025

(51) Int. Cl. G06N 5/04; G06N 20/00

(52) U.S. Cl. CPC G06N 5/04; G06N 20/00

(57) ABSTRACT

A computing system comprising one or more computing devices can obtain first alignment data. The computing system can determine, based on the first alignment data, one or more dimensions of a machine-learned embedding space associated with the first alignment data. The computing system can obtain, based on the one or more dimensions, second alignment data indicative of one or more dimension-specific preferences with respect to the one or more dimensions. The computing system can cause, based on the second alignment data, a machine-learned model to generate a preference-aligned inference output according to the one or more dimension-specific preferences.

### BACKGROUND

The present disclosure relates generally to machine learning processes and machine-learned devices and systems. A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

In some instances, an external source of feedback that is used to train a machine-learned model may provide a feedback signal that is imperfectly aligned with one or more goals or preferences for the machine-learned model, such as individualized goals or preferences of an individual user or group of users. For example, in some instances, a machine-learned model can be pretrained or fine-tuned using preference data from a large number of humans having varying goals, preferences, or tasks of interest. In such instances, traditional machine learning methods may generate outputs that align with an average or aggregate preference of a large group of users. Such average-aligned or aggregate-aligned outputs may be unsatisfactory for some users whose individual goals, preferences, or tasks of interest may differ from the average.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system comprising one or more computing devices, first alignment data. The example method can include determining, by the computing system based on the first alignment data, one or more dimensions of a machine-learned embedding space associated with the first alignment data. The example method can include obtaining, by the computing system based on the one or more dimensions, second alignment data indicative of one or more dimension-specific preferences with respect to the one or more dimensions. The example method can include causing, by the computing system based on the second alignment data, a machine-learned model to generate a preference-aligned inference output according to the one or more dimension-specific preferences.

In the example method, determining the one or more dimensions can include principal component analysis.

In the example method, determining the one or more dimensions can include one or more of factor analysis and independent component analysis.

In the example method, determining the one or more dimensions can include evaluating a metric of variance associated with the first alignment data.

In the example method, determining the one or more dimensions can include evaluating at least one of: a metric of between-user variance of the first alignment data with respect to the one or more dimensions; and a metric of same-user variance of the first alignment data with respect to the one or more dimensions.

In the example method, obtaining the second alignment data can include outputting, by the computing system based on the one or more dimensions, a query indicative of the one or more dimensions. In the example method, obtaining the second alignment data can include receiving, by the computing system responsive to the query, the one or more dimension-specific preferences with respect to the one or more dimensions.

The example method can include providing, by the computing system based on the one or more dimensions, data indicative of the one or more dimensions to a machine-learned model. The example method can include receiving, by the computing system from the machine-learned model, the query.

In the example method, the data indicative of the one or more dimensions can include a data example of the first alignment data. The example method can include determining the data example based at least in part on one or more of a magnitude of an orthogonal projection of a machine-learned embedding of the data example onto the one or more dimensions; and a metric of angular difference between the machine-learned embedding of the data example and the one or more dimensions.

In the example method, the query can include a multimodal query.

In the example method, the multimodal query can include a text component and an image component.

In the example method, causing the machine-learned model to generate a preference-aligned output can include providing, by the computing system based at least in part on the second alignment data, one or more inputs to a machine-learned model that has been trained using one or more of: third alignment data comprising a plurality of data examples indicative of the one or more dimension-specific preferences; and an objective function configured to reward outputs that align with the one or more dimension-specific preferences and to penalize outputs that do not align with the one or more dimension-specific preferences.

In the example method, the third alignment data can include a subset of the first alignment data. In the example method, the subset can be a subset that was determined based on one or more of: a plurality of magnitudes of a plurality of orthogonal projections of machine-learned embeddings associated with the first alignment data onto the one or more dimensions; and a plurality of values of a metric of angular difference between the one or more dimensions and a plurality of machine-learned embeddings associated with the first alignment data.

In the example method, causing the machine-learned model to generate the preference-aligned inference output can include providing, by the computing system to the machine-learned model, in-context learning content configured to align the preference-aligned inference output with the one or more dimension-specific preferences.

In the example method, causing the machine-learned model to generate the preference-aligned inference output can include generating, by the computing system using one or more first layers of the machine-learned model, a first embedding based on an inference input. In the example method, causing the machine-learned model to generate the preference-aligned inference output can include generating, by the computing system based at least in part on the first embedding and based at least in part on the one or more dimension-specific preferences, a second embedding. In the example method, causing the machine-learned model to generate the preference-aligned inference output can include processing, by one or more second layers of the machine-learned model, the second embedding to generate the preference-aligned inference output.

In the example method, the one or more dimensions can include a plurality of dimensions. The example method can include receiving, by the computing system, a user input. The example method can include evaluating, by the computing system based on the user input, the plurality of dimensions to generate a plurality of evaluation scores. The example method can include selecting, by the computing system based on the plurality of evaluation scores, one or more selected dimensions for obtaining alignment data. The example method can include outputting, by the computing system based on the one or more selected dimensions, a query indicative of the one or more selected dimensions. The example method can include receiving, by the computing system responsive to the query, the one or more dimension-specific preferences with respect to the one or more selected dimensions.

In the example method, the one or more selected dimensions can be selected based at least in part on data indicative of a variance of a conditional output probability distribution of the machine-learned model with respect to the one or more selected dimensions conditioned on the user input.

The example method can include clustering, by the computing system, the first alignment data by user to generate a plurality of clusters. In the example method, the one or more dimensions can be determined based on a first cluster of the plurality of clusters.

The example method can include receiving, by the computing system, a user input from a user. The example method can include performing, by the computing system, a comparison of third alignment data associated with the user to data indicative of the plurality of clusters. The example method can include performing, by the computing system based on the comparison, a cluster assignment assigning the user to the first cluster of the plurality of clusters. The example method can include outputting, by the computing system based at least in part on the cluster assignment, a query indicative of the one or more dimensions. The example method can include receiving, by the computing system responsive to the query, the one or more dimension-specific preferences with respect to the one or more dimensions.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining first alignment data. The example operations can include determining, based on the first alignment data, one or more dimensions of a machine-learned embedding space associated with the first alignment data. The example operations can include obtaining, based on the one or more dimensions, second alignment data indicative of one or more dimension-specific preferences with respect to the one or more dimensions. The example operations can include causing, based on the second alignment data, a machine-learned model to generate a preference-aligned inference output according to the one or more dimension-specific preferences.

In the example operations, determining the one or more dimensions can include one or more of principal component analysis, independent component analysis, and factor analysis.

In the example operations, obtaining the second alignment data can include outputting, by the computing system based on the one or more dimensions, a query indicative of the one or more dimensions. In the example operations, obtaining the second alignment data can include receiving, by the computing system responsive to the query, the one or more dimension-specific preferences with respect to the one or more dimensions.

Example aspects of the present disclosure provide one or more example non-transitory computer-readable media storing instructions that are executable by one or more processors to cause a computing system to perform example operations. In some implementations, the example operations can include obtaining, based on one or more dimensions of a machine-learned embedding space associated with first alignment data, second alignment data indicative of one or more dimension-specific preferences with respect to the one or more dimensions. The example operations can include causing, based on the second alignment data, a machine-learned model to generate a preference-aligned inference output according to the one or more dimension-specific preferences.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram illustrating an example system for generating aligned inference outputs based on dimensional analysis of alignment data according to example implementations of aspects of the present disclosure;

FIG. 2 is a block diagram illustrating an example system for analysis of alignment data according to example implementations of aspects of the present disclosure;

FIG. 3 is a block diagram illustrating an example system for obtaining targeted alignment feedback based on dimensional analysis of alignment data according to example implementations of aspects of the present disclosure;

FIG. 4 is a block diagram illustrating an example system for training a plurality of machine-learned models to generate aligned inference outputs based on alignment data according to example implementations of aspects of the present disclosure;

FIG. 5 is a block diagram illustrating an example system for generating aligned inference outputs based on in-context learning content generated from alignment data according to example implementations of aspects of the present disclosure;

FIG. 6 is a flow chart diagram illustrating an example method for generating aligned inference outputs based on dimensional analysis of alignment data according to example implementations of aspects of the present disclosure;

FIG. 7 is a flow chart diagram illustrating an example method for training a machine-learned model according to example implementations of aspects of the present disclosure;

FIG. 8 is a block diagram of an example processing flow for using machine-learned model(s) to process input(s) to generate output(s) according to example implementations of aspects of the present disclosure;

FIG. 9 is a block diagram of an example sequence processing model according to example implementations of aspects of the present disclosure;

FIG. 10 is a block diagram of an example technique for populating an example input sequence for processing by a sequence processing model according to example implementations of aspects of the present disclosure;

FIG. 11 is a block diagram of an example model development platform according to example implementations of aspects of the present disclosure;

FIG. 12 is a block diagram of an example training workflow for training a machine-learned model according to example implementations of aspects of the present disclosure;

FIG. 13 is a block diagram of an inference system for operating one or more machine-learned model(s) to perform inference according to example implementations of aspects of the present disclosure;

FIG. 14 is a block diagram of an example networked computing system according to example implementations of aspects of the present disclosure;

FIG. 15 is a block diagram of an example computing device according to example implementations of aspects of the present disclosure; and

FIG. 16 is a block diagram of an example computing device according to example implementations of aspects of the present disclosure.

### DETAILED DESCRIPTION

Generally, the present disclosure is directed to machine learning methods and machine-learned devices and systems. More particularly, the present disclosure is directed to systems and methods for efficiently obtaining individualized alignment information (e.g., individualized user preference data, etc.) and generating aligned machine-learned inference outputs based on the individualized alignment information. A computing system can obtain a first set of alignment data, such as user preference data from a large plurality of users. The computing system can analyze the first alignment dataset to identify one or more dimensions of interest in a machine-learned embedding space, such as dimension(s) associated with a high variance in preference values between users. Based on the identified dimension(s), the computing system can collect individualized alignment data (e.g., user preference data) for the dimension(s), and can generate one or more machine-learned inference outputs that align with the individualized alignment data.

In some instances, identifying dimension(s) of interest can include generating a plurality of machine-learned embeddings of a plurality of data examples of the first set of alignment data, and performing one or more dimensionality reduction or component analysis methods using the machine-learned embeddings. For example, in some instances, identifying dimension(s) of interest can include performing component analysis (e.g., factor analysis, principal component analysis, etc.) to identify one or more dimension(s) associated with a high (e.g., maximum, etc.) value for a metric of variance, such as a metric of between-user variance along the dimension(s). As another example, in some instances, identifying dimension(s) of interest can include performing component analysis (e.g., independent component analysis, factor analysis, etc.) to identify one or more dimension(s) associated with a low (e.g., zero, minimum, etc.) value for a metric of correlation or covariance, such as a set of dimension(s) of interest that are statistically independent from each other. In some instances, dimensionality reduction can include identifying a ranked plurality of dimensions (e.g., ranked according to a metric of variance, etc.), and selecting the top k dimensions from the ranking, where k can be a positive integer.

In some instances, obtaining individualized alignment data for the dimension(s) of interest can include generating one or more queries (e.g., alignment questions, etc.) based on the dimension(s); providing the one or more queries to an entity (e.g., user, computing device, machine-learned agent, etc.); and receiving individualized alignment data in response to the one or more queries. For example, in some instances, generating a query based on a dimension of interest can include identifying one or more data examples (e.g., from the first alignment data, etc.) associated with the dimension of interest, such as data example(s) having a high (e.g., maximum, etc.) or low (e.g., near zero, maximally negative, etc.) magnitude on the dimension of interest (e.g., dot product with the dimension of interest, etc.); data example(s) having a low angular distance (e.g., cosine distance, etc.) from the dimension of interest; or the like. In some instances, generating a query based on the dimension of interest can include providing the data example(s) to a machine-learned model (e.g., natural language model), and generating the query based on the data example(s) of interest. Other implementations are possible.

In some instances, individualized alignment data can be obtained before or after receiving a user query for which an individually aligned machine-learned inference output will be generated. For example, in some instances, a set of k dimension(s) of interest can be identified, and k alignment questions can be provided to a user upon signup for a machine learning service. As another example, in some instances, a computing system can receive a user query from a new user, which the computing system may have no individualized alignment data for, and may obtain individualized alignment data responsive to the user query. For example, the computing system can identify, based on the user query, at least one dimension that is particularly relevant to the user query; provide an alignment question to the user based on the dimension; and generate a machine-learned inference output based on a response to the alignment question received from the user. For example, in some instances, a particularly relevant dimension can include a dimension along which a conditional output probability distribution of a machine-learned model, conditioned on the user query, has high variance.

Generating aligned inference outputs based on individualized alignment data can be performed in various ways. For example, in some instances, a plurality of machine-learned models can be fine-tuned for a plurality of combinations of individual alignment values, and generating an aligned inference output can include selecting a machine-learned model of the plurality of machine-learned models based on individualized alignment data, and generating an inference output using the selected model. As a non-limiting illustrative example, if k dimensions of interest comprise a verbosity dimension, a formality dimension, and an obsequiousness dimension, then an example machine-learned model can include a high-verbosity/low-formality/medium-obsequiousness model that has been fine-tuned or preference data from users who have shown a preference for inference outputs having high verbosity, low formality, and near-median levels of obsequiousness; a model that has been fine-tuned using an objective function that rewards high verbosity and low formality; or the like.

As another example, in some instances, generating an aligned inference output can include influencing a general-purpose machine-learned model based on the individualized alignment data to cause the model to generate aligned inference outputs. For example, in some instances, influencing a machine-learned model based on individualized alignment data can include providing in-context learning inputs to the machine-learned model, such as instruction content instructing the model to generate outputs having individualized alignment properties; few-shot or chain-of-thought examples comprising example outputs having individualized alignment properties; or other in-context learning content. In some instances, in-context learning content can include content used to fine-tune a machine-learned model for generating aligned outputs, such as one or more specialized input tokens indicative of corresponding dimension-specific preference(s), which can be input to a model that was fine-tuned to generate preference-aligned outputs responsive to the specialized input token(s). In some instances, in-context learning content can include a vector-based input, such as a soft prompt vector that has been optimized (e.g., using fine-tuning, etc.) to cause a machine-learned model to generate preference-aligned outputs; a vector indicative of a plurality of dimension-specific preferences; or other vector content. As another example, in some instances, influencing a machine-learned model based on individualized alignment data can include directly adjusting one or more activations of the machine-learned model during an inference process, such as by combining (e.g., adding, multiplying, etc.) a layer output of a layer of the machine-learned model with a machine-learned embedding indicative of a user’s individual alignment preferences. Other examples are possible.

In some instances, processes described herein can be performed using preference data associated with all users of a computing system, or with specific subsets of users. For example, in some instances, users can be grouped by organization (e.g., employer, etc.) or other grouping (e.g., access control list, membership list, country or other location data, user settings, demographic data, etc.). For each group, group-specific dimension(s) of interest indicative of high variance in preferences between users in that group can be identified; group-specific individualized alignment data can be obtained for the group-specific dimension(s); and aligned inference outputs can be generated based on the group-specific individualized alignment data. In some instances, a user may belong to more than one group (e.g., subdivision of an organization, project group, etc.), and aligned inference outputs can be generated based on group-specific individualized alignment data from a plurality of groups (e.g., instead of or in addition to non-group-specific individualized alignment data).

Example embodiments according to some aspects of the present disclosure can provide for a number of technical effects and benefits, such as improvements to computing technology (e.g., machine learning technology. For example, in some instances, systems and methods according to some aspects of the present disclosure can provide improved quality of inference outputs compared to some alternative implementations, such as improved alignment between inference output properties and user-specific preferences, tasks, or goals. As another example, in some instances, systems and methods according to some aspects of the present disclosure can provide similar-quality (e.g., same-quality, etc.) machine-learned inference outputs at a reduced cost (e.g., reduced computational cost of inference, reduced training cost, reduced data collection cost, etc.) compared to some alternative implementations.

In some instances, systems and methods according to some aspects of the present disclosure can provide improved alignment between inference outputs and user preferences, tasks, or goals. For example, some alternative implementations may include obtaining undifferentiated alignment data from a large group of users (e.g., all users of a computing system), which may cause a machine-learned model to generate suboptimal or undesirable outputs for users whose preferences, goals, or tasks may be different from a group average. As a non-limiting illustrative example, a group of employees of a company may include engineers who may prefer highly detailed, focused, or technical outputs for some tasks, along with executive employees who may prefer concise, broad, less-technical summary outputs for some tasks. In such instances, systems and methods according to aspects of the present disclosure can improve the functioning of the computing system and machine-learned inference technology by better identifying and complying with implicit task definitions that may not be detected by some alternative implementations.

In some instances, systems and methods according to some aspects of the present disclosure can provide similar-quality (e.g., same-quality, etc.) machine-learned inference outputs at a reduced cost (e.g., reduced computational cost of inference, reduced training cost, reduced data collection cost, etc.) compared to some alternative implementations. For example, in some instances, systems and methods according to some aspects of the present disclosure can reduce a cost of data collection for individualized alignment by rapidly identifying a short list of highly relevant alignment dimensions to focus a data collection process. As a non-limiting illustrative example, systems and methods according to some aspects of the present disclosure can identify a small number (e.g., five, ten, etc.) of highly relevant alignment questions to ask user(s), and can rapidly align with users’ most important individualized preferences based on a small number of questions, thereby reducing a cost of data collection compared to some alternative implementations (e.g., implementations involving large numbers of ad hoc questions, implementations that solicit feedback for large numbers of example inference outputs, etc.).

Additionally, in some instances, systems and methods according to some aspects of the present disclosure can reduce a computational cost of data collection compared to some alternative implementations. For example, in some instances, an alternative implementation can include generating, for each individual user, one or more first inference outputs; soliciting alignment feedback from the individual user for the first inference output(s); and generating a second inference output based on the alignment feedback. However, generating a plurality of first inference outputs can in some instances be computationally expensive, and receiving enough feedback for satisfactory alignment can require a large number of first inference outputs in some alternative implementations (e.g., implementations that do not identify or target the most relevant feedback dimensions, etc.). Advantageously, systems and methods according to some aspects of the present disclosure can generate aligned inference outputs using fewer alignment queries, lower-cost alignment queries (e.g., predetermined questions retrieved from a static database, etc.), or both compared to some alternative implementations.

Additionally, in some instances, systems and methods according to some aspects of the present disclosure can reduce a computational cost of machine-learned inference compared to some alternative implementations. For example, some alternative implementations may generate first draft inference outputs that are less aligned with user preferences, tasks, or goals compared to some implementations according to aspects of the present disclosure. In such instances, generating a satisfactory inference output may require receiving alignment feedback from a user, and generating a second draft inference output based on the alignment feedback. In some alternative implementations, such a feedback-redrafting loop may be repeated several times until a user is satisfied with a later inference output. Advantageously, systems and methods according to some aspects of the present disclosure can generate better aligned first draft outputs compared to some alternative implementations (e.g., by identifying the most relevant alignment dimensions for a given input or task, and soliciting targeted alignment feedback before generating a first draft output, etc.), thereby reducing a number of draft inference outputs generated and reducing an overall computational cost of inference.

Various example implementations are described herein with respect to the accompanying Figures.

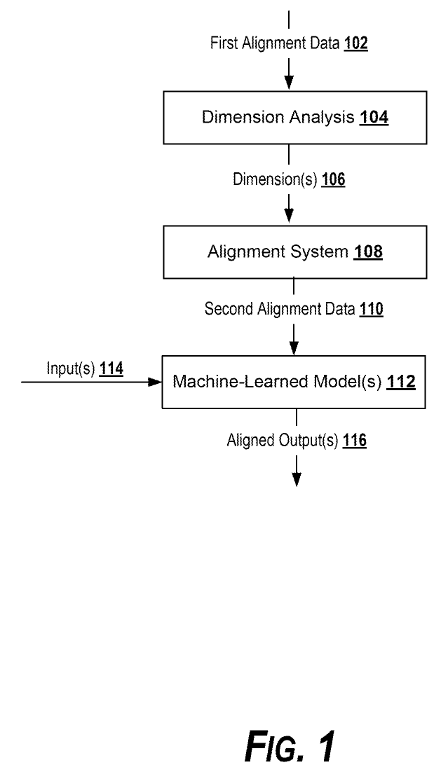

FIG. 1 is a block diagram illustrating an example system for generating aligned inference outputs based on dimensional analysis of alignment data according to example implementations of aspects of the present disclosure. A dimension analysis system 104 can obtain (e.g., receive, retrieve, generate, etc.) first alignment data 102 and can perform a dimension analysis on the first alignment data 102 to identify one or more dimensions 106 of interest. Based on the dimension(s) 106, an alignment system 108 can obtain (e.g., receive, generate, etc.) second alignment data 110 indicative of one or more individualized (e.g., user-specific, account-specific, organization-specific, computing-system-specific, etc.) preferences with respect to the dimension(s) 106. Based on the second alignment data 110 and one or more inputs 114, a machine-learned model 112 can generate one or more aligned outputs 116 that conform to the one or more individualized preferences.

First alignment data 102 can generally include or otherwise represent various types of data. First alignment data 102 can include one type or many different types of data. Example data that can be included in first alignment data 102 can include feedback data provided by one or more users or other entities (e.g., computing systems, machine-learned models, organizations, user accounts, etc.), such as numerical feedback (e.g., rating on a scale of one to ten, etc.), natural language feedback (e.g., natural language answer to a feedback question; natural language user input providing feedback on a machine-learned inference output; etc.), feedback input(s) (e.g., button clicks, such as thumbs up or down button click; keyboard inputs; audio inputs; or other inputs); feedback determined from user behavior (e.g., user activity or inactivity, such as asking or not asking followup questions in response to a machine-learned output; continuing to use or not continuing to use a machine-learned model or machine learning service; copying all or part of a machine-learned output to a clipboard of a computing device or operating system; or other behavior indicative of satisfaction or dissatisfaction with a machine-learned output.). In some instances, feedback data can include one or more input-output-feedback tuples, such as a tuple comprising an input provided by a user (e.g., natural language input, text input, audio input, visual input, etc.), one or more corresponding machine-learned inference outputs (e.g., pairs or sets of candidate inference outputs for a user to select from, etc.) generated by a machine-learned model (e.g., machine-learned model 112, etc.) based on the input, and data indicative of one or more feedback inputs provided by the user, the feedback input(s) being indicative of a quality or user satisfaction level associated with the inference output(s) (e.g., numerical feedback inputs, accept/reject feedback inputs, natural language feedback inputs such as edit requests, behavioral feedback inputs such as copying to clipboard, etc.). As another example, feedback data can in some instances include one or more query-feedback tuples (e.g., question-answer pairs, etc.), such as a query provided to a user (e.g., question about specific preferences for a machine-learned inference operation, etc.) and a corresponding feedback input received from the user in response to the query.

In some instances, first alignment data 102 can include alignment data (e.g., feedback input(s) etc.) received directly from a user or other entity or obtained in another manner, such as data generated based on data associated with a user. For example, in some instances, a feedback input can include data indicative of user satisfaction or dissatisfaction, such as one or more followup inputs (e.g., natural language followup input(s), button clicks, edits to a machine-learned inference output, etc.) indicative of satisfaction or dissatisfaction, data indicative of activity or inactivity of a user (e.g., time period between uses of a machine learning system, etc.), or other data indicative of satisfaction or dissatisfaction. As a non-limiting illustrative example, a followup input comprising an edit to a machine-learned inference output can be indicative of satisfaction with some parts of the inference outputs (e.g., parts that are not changed in the editing, etc.) and dissatisfaction with other parts (e.g., parts that are changed by editing, etc.). As another non-limiting illustrative example, natural language inputs comprising words with positive valence (e.g., “Thanks!”; “That’s perfect”; etc.) can be indicative of user satisfaction, while natural language inputs comprising negative words or requesting a change to the inference outputs can be indicative of dissatisfaction. As another example, natural language inputs making duplicative inference requests (e.g., requesting the same thing as a previous inference request, with slight changes to a wording of the input) can be indicative of dissatisfaction with a prior input, while natural language inputs requesting new or unrelated inference actions may be indicative of user satisfaction with prior inferences. Other examples are possible.

In some instances, obtaining first alignment data 102 can include analyzing user feedback data using a machine-learned model or other system. As a non-limiting illustrative example, in some instances, determining first alignment data 102 from user feedback inputs can include providing data indicative of user input(s) to a machine-learned feedback evaluation model (e.g., fine-tuned model, general-purpose model, etc.) and receiving, from the feedback evaluation model, data (e.g., a numerical score or rating, a Boolean satisfaction/dissatisfaction indicator, etc.) indicative of an estimated user satisfaction or dissatisfaction level expressed by the input(s). In some instances, a feedback evaluation model can also be provided with in-context learning content to cause the model to generate first alignment data 102 from raw feedback inputs, such as in-context learning content comprising instructions to evaluate the inputs for user satisfaction levels; few-shot prompting content or chain-of-thought prompting content; example input-output pairs comprising feedback inputs and alignment evaluation outputs; example input-reasoning-output tuples comprising feedback inputs, chain-of-reasoning content associated with the feedback inputs, and alignment evaluation outputs associated with the feedback inputs and chains of reasoning.

In some instances, first alignment data 102 can include or not include compiled data (e.g., summary data, aggregate data such as statistical aggregate data, etc.) generated from a plurality of feedback data examples. As a non-limiting illustrative example, in some instances, first alignment data 102 can include a statistical aggregate value (e.g., mean, median, minimum, maximum, variance, covariance, correlation, etc.) associated with a plurality of feedback values, such as an average of a plurality of feedback scores (e.g., scores associated with a user; scores associated with output(s) having a particular property, such as output length, format, semantic content, topic, inclusion or exclusion of particular words, or other property; etc.) or correlation between feedback score and another property (e.g., length, format, etc.) for a plurality of feedback scores. As another example, in some instances, first alignment data 102 can include compiled data generated from related pairs of feedback inputs, such as feedback associated with related pairs of generated outputs. For example, in some instances, first alignment data 102 can include compiled data generated based on a first candidate output that was approved by a user and a second candidate output that was generated based on a similar (e.g., same, etc.) input compared to the first candidate output, wherein the second candidate output was not approved by the user. In some instances, a candidate output can include an output segment, such as a sentence of a generated paragraph, document, or the like. For example, in some instances, a machine-generated output can be provided to a user via a graphical user interface that enables direct editing of the machine-generated output by the user. In such instances, a second candidate output can include a portion of the machine-generated output that was deleted or edited by the user, and a first candidate output can include a portion that was retained (e.g., unmodified or with only minor modifications, etc.) by the user. In some instances, compiled first alignment data 102 based on candidate outputs can include compiled data based on machine-learned embeddings of the candidate outputs, such as first alignment data 102 comprising a difference (e.g., difference determined using vector arithmetic such as subtraction) between two embedding values; a single combined machine-learned embedding generated by providing a first candidate output and a second candidate output (e.g., in combination with data indicative of feedback input(s) associated with the candidate outputs, etc.) to a machine-learned embedding model; or other combination of embeddings (e.g., average-pooled combination, summed embeddings, etc.).

In some instances, first alignment data 102 can include alignment data obtained or generated based on all users of a plurality of users (e.g., all users of a computing system, application, or the like), or based on one or more subsets of the plurality of users. For example, in some instances, feedback data associated with a plurality of users can be clustered, and a dimension analysis 104 can be performed on cluster-specific first alignment data 102 to generate cluster-specific dimension(s) 106 for one or more clusters (e.g., clusters of users, semantic clusters of user inputs associated with the first alignment data 102, etc.). In some instances, clustering of users can be based on one or more inputs received from the users, such as feedback inputs, machine-learned inference inputs, or other inputs. For example, in some instances, semantic embeddings of a plurality of machine-learned inference inputs can be determined, and users can be clustered based on the embeddings (e.g., based on each users’ most-asked-about topics, etc.). As another example, in some instances, users can be clustered based on each user’s feedback input(s) (e.g., natural language follow-up requests, thumbs up or thumbs down feedback inputs, etc.), such as based on aggregate value(s) (e.g., averages, counts, correlations, embedding values, pooled embedding values, etc.) determined from the feedback inputs. As another example, in some instances, a subset of users can include a subset associated with an organization or group, such as an enterprise, business, social media group, project group, or the like. As another example, in some instances, a subset of users can include a subset of users having one or more common characteristics, such as users who use a system for similar tasks or provide similar inputs; users having one or more common demographic characteristics such as age, profession, country, or the like; users having one or more common account characteristics such as role, access permissions, or the like; users having a number of feedback inputs greater than a threshold; users having similar account settings; or other subsets.

In some instances, clustering (e.g., clustering a plurality of users to generate user clusters, etc.) can include clustering based on one or more machine-learned embeddings. For example, in some instances, feedback data from each user of a plurality of users can be embedded by a feedback embedding model, and the users can be clustered based on the feedback embeddings. As another example, input(s) associated with the user (e.g., inference inputs received from the user, inputs of an input-output-feedback tuple associated with the user, etc.) or other data associated with the user can be embedded using a semantic embedding model (e.g., sentence embedding, paragraph embedding, document embedding, etc.), and the user(s) can be clustered based on the embeddings (e.g., according to k means clustering, g means clustering, etc.). In some instances, each user can be associated with one embedding or a plurality of embeddings used in the clustering. In some instances, a plurality of embeddings can be combined or pooled (e.g., average pooled, etc.) to generate a combined embedding for each user, and users can be clustered based on the combined embedding(s). In some instances, clustering can include clustering that is not user clustering, such as clustering of datapoints (e.g., clustering of semantic embeddings inputs of input-output-feedback datapoints, etc.) or the like.

In some instances, a user can belong to one group or a plurality of groups (e.g., clusters, etc.). In some instances, a first alignment data 102 data example can belong to one group or a plurality of groups, and can be used in a group-specific dimension analysis for one group or a plurality of groups.

In some instances, first alignment data 102 can include alignment data associated with one or more modes (e.g., data types such as text, image, audio, video, etc.) associated with one or more multimodal machine-learned models. As a non-limiting illustrative example, in some instances, first alignment data 102 can include one or more of: alignment data based on one or more first-mode outputs (e.g., text-only outputs, natural language outputs, etc.) of a multimodal machine-learned model; alignment data based on one or more second-mode outputs (e.g., image outputs, video outputs, audio outputs, etc.) of the multimodal machine-learned model; and alignment data based on one or more multimodal outputs (e.g., combined text-and-image output; combined audio-and-video output, etc.) of the multimodal machine-learned model. In such instances, alignment data associated with each of a plurality of modes can be considered separately or together. For example, in some instances, dimension analysis 104 can include a first dimension analysis 104 to select one or more dimensions 106 associated with a first output mode (e.g., text outputs, audio outputs, etc.); a second dimension analysis 104 to select one or more alignment dimensions 106 associated with a second output mode (e.g., image outputs, video outputs, etc.) etc.); a third dimension analysis 104 to select one or more alignment dimensions 106 associated with a multimodal output mode (e.g., combined first-and-second output mode, such as combined text-and-image output mode, combined video-and-audio mode, etc.); and so on. As another example, in some instances, dimension analysis 104 can include a single dimension analysis 104 to select dimension(s) 106 associated with a plurality of output modes or mode combinations, such as a single dimension analysis 104 using all first alignment data 102 irrespective of output mode. Other examples are possible. In instances where a first set of dimension(s) 106 and second set of dimension(s) 106 are selected based on a first and second mode or first and second combination of modes, second alignment data 110 can in some instances be provided based at least in part on a corresponding mode associated with the input(s) 114 or aligned output(s) 116 (e.g., requested output mode included in the input(s) 114; output mode of the aligned output(s) 116; etc.).

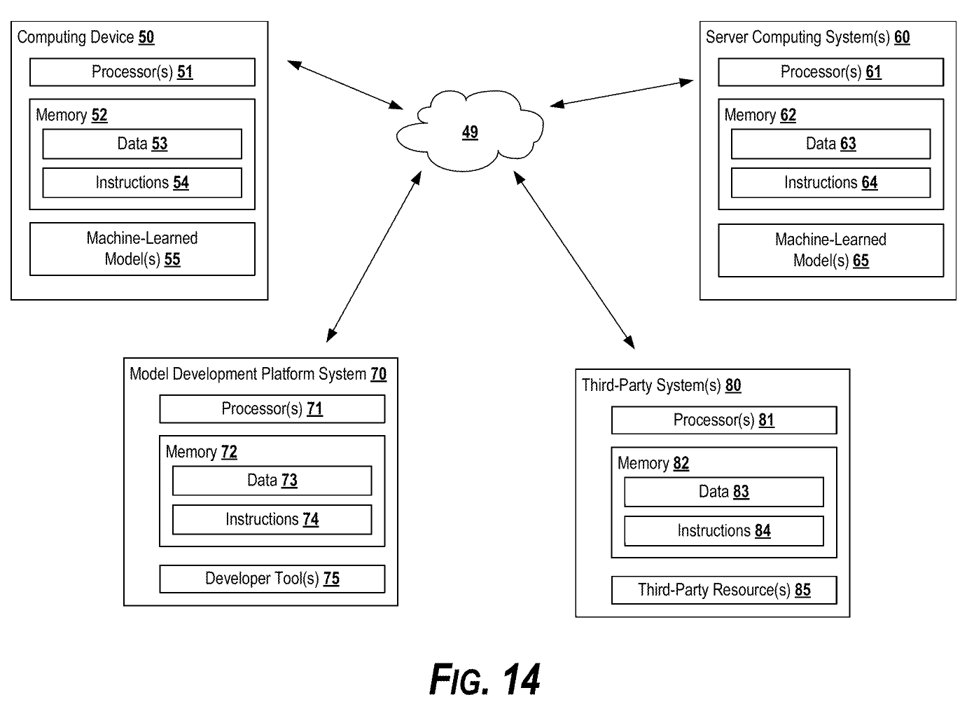

A dimension analysis system 104 can be or include one or more software, firmware, or hardware components configured to perform dimension analysis. In some instances, the dimension analysis system 104 can be, comprise, be comprised by, or share one or more properties with a computing device or system described below with respect to FIGS. 14-16 (e.g., computing device 50, third-party system 80, computing device 98, computing device 99, etc.).

Dimension analysis can include, for example, any method for identifying dimensions of interest from raw data. In some instances, dimension analysis can include one or more dimensionality reduction methods. In some instances, dimension analysis can include evaluating (e.g., scoring, rating, ranking, etc.) each of a plurality of dimensions according to a metric of relevance, and determining (e.g., identifying, selecting, etc.) one or more dimensions of interest based on the evaluations. In some instances, a metric of relevance can include a metric of variance associated with a dimension; a metric of statistical correlation (e.g., a metric of statistical independence, etc.) between a dimension and one or more other dimensions; a metric of covariance between first alignment 102 data examples; or other metric of dimensional relevance. In some instances, a metric of variance can include a user-blind metric of variance; a metric of within-user variance (i.e., same-user variance); a metric of between-user variance; or other variance metric. In some instances, a metric of variance can include a metric of variance associated with a principal component analysis, such as a metric of variance for determining which dimension of a plurality of linear transformations of a first plurality of dimensions (e.g., of an embedding space, etc.) captures a large (e.g., the largest, etc.) variation in the first alignment 102 data. In some instances, a metric of correlation can include a metric of correlation associated with a factor analysis, such as a metric of variance that encourages selection of a smallest set of dimension(s) 106 that accounts for a correlation associated with the first alignment data 102. In some instances, a metric of independence can include a metric of mutual information (e.g., entropy, Kullback-Leibler divergence, etc.), such as a metric that encourages the selection of a set of dimension(s) 106 that reduce (e.g., minimize, nearly minimize, etc.) an amount of mutual information between the dimension(s). In some instances, a metric of relevance can include a metric of Gaussianity (e.g., kurtosis, negentropy, etc.), such as a metric that encourages the selection of a set of dimension(s) 106 that increase (e.g., maximize, nearly maximize, reduce relative to other candidate sets of dimensions, etc.) a metric of non-Gaussianity. In some instances, a metric of independence can include a metric associated with an eigendecomposition, such as a singular value of a dimension determined according to a singular value decomposition.

In some instances, a metric of relevance can include a metric of relevance that is based at least in part on user-specific first alignment data 102, or a metric of relevance that does not rely on user-specific data. In some instances, a metric based in part on user-specific first alignment data 102 can include a metric that rewards between-user variance, such as a metric that causes a dimension to be more likely to be identified as a dimension 106 of interest if a between-user variance of evaluation scores or other feedback data is higher, and less likely if the between-user variance is lower. In some instances, a metric based in part on user-specific first alignment data 102 can include a metric that penalizes within-user variances, such as a metric that causes a dimension to be more likely to be identified as a dimension 106 of interest if an average user provides highly consistent feedback with respect to the dimension, and less likely to be identified as a dimension 106 of interest if an average within-user variance of feedback scores with respect to the dimension is high. In some instances, a metric of relevance can include a user-blind metric of relevance that does not rely on user-specific data, such as a metric that depends equally on all data examples of the first alignment data 102, without regard to an identity of a user associated with a respective data example.

In some instances, dimension analysis can include performing one or more of principal component analysis, factor analysis, independent component analysis, or other component analysis method. In some instances, dimension analysis can include performing one or more dimensionality reduction methods (e.g., principal component analysis (PCA), singular value decomposition, kernel PCA, graph-based kernel PCA, discriminant analysis, t-distributed stochastic neighbor embedding, uniform manifold approximation and projection, etc.). In some instances, dimension analysis can include ranking dimensions according to a metric of relevance and selecting one or more dimension(s) 106 based on the ranking (e.g., top k ranked dimensions, etc.).

In some instances, dimension analysis can include dimension analysis based on first alignment data 102 associated with all users of a plurality of users, or subset-specific (e.g., cluster-specific, etc.) first alignment data 102. For example, in some instances, dimension analysis can include performing, for each of a plurality of groups (e.g., clusters, organizations, access control lists, etc.), a group-specific dimension analysis, such as a dimension analysis that evaluates, increases (e.g., maximizes or nearly maximizes, etc.), or decreases (e.g., minimizes or nearly minimizes, etc.) a group-specific metric of relevance, such as a metric of variance (e.g., between-user variance between users of that group, user-blind variance, etc.) or correlation evaluated based on group-specific first alignment data 102 associated with each respective group.

In some instances, dimension analysis can include selecting a plurality of dimensions 106 according to one or more selection rules, such as one or more selection rules based on one or more metrics of relevance. For example, in some instances, selecting a plurality of dimensions 106 can include selecting a predetermined number (e.g., 5, 10, etc.) of dimensions based on a ranking according to a metric of relevance. As a non-limiting illustrative example, in some instances, selecting a plurality of dimensions 106 can include using principal component analysis to rank a plurality of dimensions according to an amount of explained variance associated with the dimensions, and selecting a top k dimensions 106 from the ranked plurality of dimensions, where k can be a predetermined positive integer (e.g., 5, 10, etc.). As another example, in some instances, selecting a plurality of dimensions 106 can include selecting a plurality of dimensions 106 based at least in part on a predetermined threshold associated with a metric of relevance. As a non-limiting illustrative example, in some instances, selecting a plurality of dimensions 106 can include selecting all dimensions 106 having an amount of explained variance that exceeds a variance threshold, such as a threshold percentage of a total amount of variance associated with the first alignment data 102; a threshold raw variance value; or other variance threshold. In some instances, selecting dimension(s) 106 can include selecting a plurality of candidate dimensions according to one or more first selection rules, and selecting one or more dimensions 106 based on one or more second selection rules. As a non-limiting illustrative example, in some instances, selecting dimension(s) 106 can include identifying a pool of candidate dimensions 106 based on a predetermined threshold associated with a first metric of relevance (e.g., variance determined according to a principal component analysis, etc.); identifying a predetermined number of top-ranked candidate dimensions according to a first metric of relevance (e.g., variance determined according to a principal component analysis, etc.); or the like. Continuing the non-limiting illustrative example, in some instances, selecting dimension(s) 106 can include selecting from the pool of candidate dimensions 106 according to one or more second metrics of relevance, such as within-user or between-user variance; machine-learned metric of relevance; or other metric.

In some instances, dimension analysis can include determining a plurality of candidate dimensions (e.g., using component analysis, based on variance, or according to any other method described herein, etc.) and then filtering the candidate dimensions to select one or more dimensions 106 of interest. For example, in some instances, filtering can include separating preference-based dimensions from non-preference-based candidate dimensions. As a non-limiting illustrative example, in some instances, a plurality of generated outputs (e.g., machine-generated outputs contained in the first alignment data 102, etc.) can be retrieved based on a candidate dimension (e.g., by orthogonally projecting embeddings of a plurality of generated outputs of the candidate dimension, and selecting the top few highest-magnitude projections, etc.), and the generated outputs can be provided to a machine-learned model configured (e.g., fine-tuned, prompted, etc.) to identify what the generated outputs have in common. For example, the machine-learned model can be configured to determine whether the generated outputs are related to a similar topic; have a similar format, tone, style, or other property; or have other properties in common. In some instances, candidate dimensions associated with a common topic can be rejected, and candidate dimensions associated with a style preference or other alignment preference can be selected (e.g., by a machine-learned model based on the generated outputs, etc.) as dimensions 106. However, this is not required. For example, in some instances, a first alignment data 102 dataset or metric of relevance can be configured to automatically identify preference-related dimensions 106 without flagging topic-related embedding dimensions or the like. As a non-limiting illustrative example, in some instances, a first alignment data 102 having a balanced mix of a wide variety of topics can be obtained, such that topic-related embedding dimensions will not be flagged as candidate dimensions of interest. As another example, in some instances, a metric of relevance of first alignment data 102 dataset can include a metric or dataset that may control for confounding variables (e.g., using paired data, using one or more other statistical methods, etc.) such that topic-related dimensions are not flagged as candidate dimensions of interest.

Dimension(s) 106 can include, for example, data indicative of one or more dimensions determined by a dimension analysis system 104, such as dimensions of a machine-learned embedding space. In some instances, a machine-learned embedding space can include an embedding space associated with a machine-learned model that is the same as or different from the machine-learned model 112. For example, in some instances, a machine-learned embedding space can include an embedding space associated with a semantic embedding model (e.g., sentence embedding model, paragraph embedding model, document embedding model, etc.) configured to embed a sequence output into an n-dimensional embedding vector, wherein n can be a positive integer. As another example, in some instances, a machine-learned embedding space can include an embedding space associated with a first N layers of the machine-learned model 112, wherein N can be a positive integer (e.g., between 5 percent and 95 percent of a total number of layers of the machine-learned model 112, such as between 20 and 80percent, such as between 40 and 60 percent, etc.). In some instances, a data type for representing a dimension 106 can include a tensor (e.g., one-dimensional “vector” tensor, matrix, etc.) of numerical values, such as a vector of magnitudes of the dimension 106 in a plurality of basis directions associated with the embedding space. For example, in some instances, a machine-learned model (e.g., embedding model, etc.) can be configured to output (e.g., based on natural language inputs, etc.) embedding vectors comprising a plurality of numerical values (e.g., intermediate activations of the machine-learned model 112, outputs of a separate embedding model, etc.), wherein each entry (e.g., row, column, cell, etc.) of the vector is associated with a basis direction in an embedding space of the machine-learned model.

In some instances, a plurality of dimensions 106 can include a plurality of dimensions 106 that are orthogonal to each other. For example, in some instances, dimension analysis can include selecting (e.g., using principal component analysis, etc.) a first dimension 106 (e.g., dimension that maximizes a variance metric, etc.) from a plurality of possible candidate dimensions; selecting a second dimension 106 from a first subset of the plurality of possible candidate dimensions, wherein each candidate dimension of the first subset is orthogonal to the first dimension; selecting a third dimension 106 from a subset of candidate dimensions that are orthogonal to the first and second dimensions 106 (e.g., all orthogonal dimensions of an embedding space, etc.); and so on.

In some instances, dimensions 106 can include any set of dimensions determined according to one or more methods described above with respect to a dimension analysis system 104, such as a set of factors determined according to a factor analysis method; a set of principal components determined via principal component analysis; or other set of dimensions determined according to one or more methods described above.

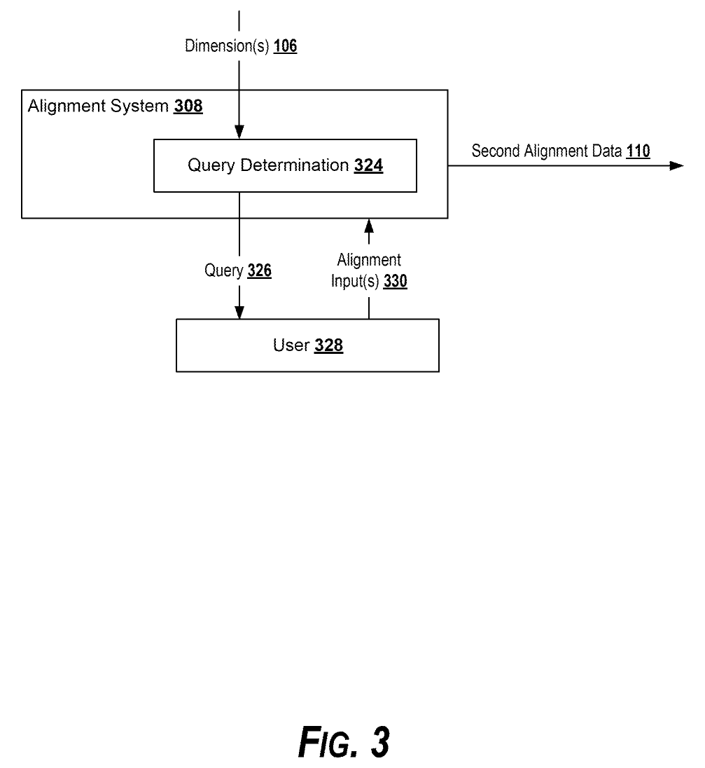

An alignment system 108 can be or include one or more software, firmware, or hardware components configured to obtain (e.g., receive, retrieve, generate, solicit, etc.) second alignment data 110 based on dimension(s) 106. In some instances, an alignment system 108 can include a device or component (e.g., computing device, processor device, etc.) that is the same as or different from a device or component of the dimension analysis system 104. In some instances, the alignment system 108 can be, comprise, be comprised by, or share one or more properties with a computing device or system described below with respect to FIGS. 14-16 (e.g., computing device 50, third-party system 80, computing device 98, computing device 99, etc.). Further details of an example alignment system according to some aspects of the present disclosure are provided below with respect to FIG. 3 and alignment system 308.

Second alignment data 110 can generally include or otherwise represent various types of data. Second alignment data 110 can include one type or many different types of data. In some instances, second alignment data 110 can include data that is the same as or different from data described above with respect to first alignment data 102. For example, in some instances, second alignment data 110 can have any property described above with respect to first alignment data 102, and vice versa. In some instances, second alignment data 110 can include individualized (e.g., user-specific, account-specific, device-specific, organization-specific, etc.) alignment data 110 obtained (e.g., determined, generated, received, solicited, etc.) based at least in part on dimension(s) 106. In some instances, second alignment data 110 can include dimension-specific individualized alignment data 110 for each of one or more dimensions 106, such as an individualized preference score (e.g., on a scale of 1 to 5, 1 to 100, “very important” to “not important”, etc.) associated with each dimension 106; a preferred position on an axis associated with each dimension 106; one or more position-feedback pairs comprising a feedback score given by a user based on a machine-learned inference output and a corresponding position of the inference output on an axis associated with the dimension 106; or other dimension-specific individualized alignment data 110. A position of an inference output on a dimension 106 axis can include, for example, a magnitude (or magnitude and sign, etc.) of an orthogonal projection of an embedding associated with the inference output onto the dimension 106.

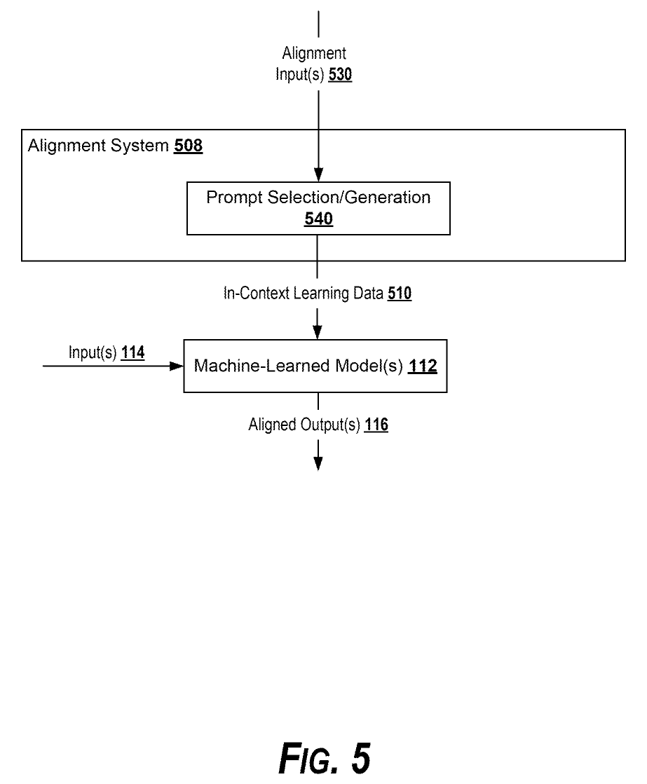

In some instances, second alignment data 110 can include data in a format (e.g., token format, natural language format, vector format, etc.) configured to be provided as input to a machine-learned model 112 to cause the machine-learned model 112 to output aligned outputs 116. In some instances, data to be provided as input to a machine-learned model 112 can include data that is the same as or different from (or data having a data type that is the same as or different from) second alignment data 110 received from a user; second alignment data 110 generated based on feedback data received from a user; second alignment data 110 stored in a data structure (e.g., database, file, etc.); or other second alignment data 110. Further details of some example alignment data configured to be provided as input to a machine-learned model 112 to cause the machine-learned model 112 to output aligned outputs 116 according to some aspects of the present disclosure are provided below with respect to FIG. 5 and in-context learning data 510.

In some instances, second alignment data 110 can be obtained in any manner described below with respect to FIG. 3; any manner described above with respect to first alignment data 102; or other appropriate manner based at least in part on dimension(s) 106.

The machine-learned model(s) 112 can include one or more machine-learned models. The machine-learned model(s) 112 can include various model architectures, such as various neural network model architectures. An example model architecture for a machine-learned model(s) 112 can include a sequence processing model architecture (e.g., a transformer model). For example, the machine-learned model(s) 112 can be configured to receive an input sequence and generate an output sequence. For instance, the machine-learned model(s) 112 can be configured to generate an output sequence where elements of the output sequence are predicted based on the elements of the input sequence. In some instances, a machine-learned model 112 can include a model architecture having an attention mechanism (e.g., self-attention). In some instances, the machine-learned model 112 can be a pre-trained model (e.g., pretrained using large-scale unsupervised learning). In some instances, the machine-learned model 112 can be fine-tuned over one or more fine-tuning datasets, such as a fine-tuning dataset associated with one or more specialized generation tasks.

In some instances, the machine-learned model 112 can include a multimodal machine-learned model. In some instances, a multimodal machine-learned model 112 can include a multimodal machine-learned model configured to receive, as input, one or more of: alignment data (e.g., natural language alignment data, numerical alignment data, alignment embedding tensor data, etc.), text data (e.g., natural language text data, computer code data, structured text data such as JSON-structured text data, etc.), natural language data (e.g., text data, speech data, etc.), image data, audio data (e.g., speech data, music data, etc.), video data, or other input type. In some instances, a multimodal machine-learned model 112 can include a multimodal machine-learned model configured to provide, as output, one or more of: alignment data (e.g., natural language alignment data, numerical alignment data, alignment embedding tensor data, etc.), text data (e.g., natural language text data, computer code data, structured text data such as JSON-structured text data, etc.), natural language data (e.g., text data, speech data, etc.), image data, audio data (e.g., speech data, music data, etc.), video data, or other input type. As a non-limiting illustrative example, a multimodal machine-learned model 112 can include a multimodal sequence processing model (e.g., Google Gemini, etc.) configured to receive, as input, one or both of text data and image data; and provide, as output, one or both of text data and input data (e.g., wherein a data type of a generated output can depend at least in part on an input context, etc.).

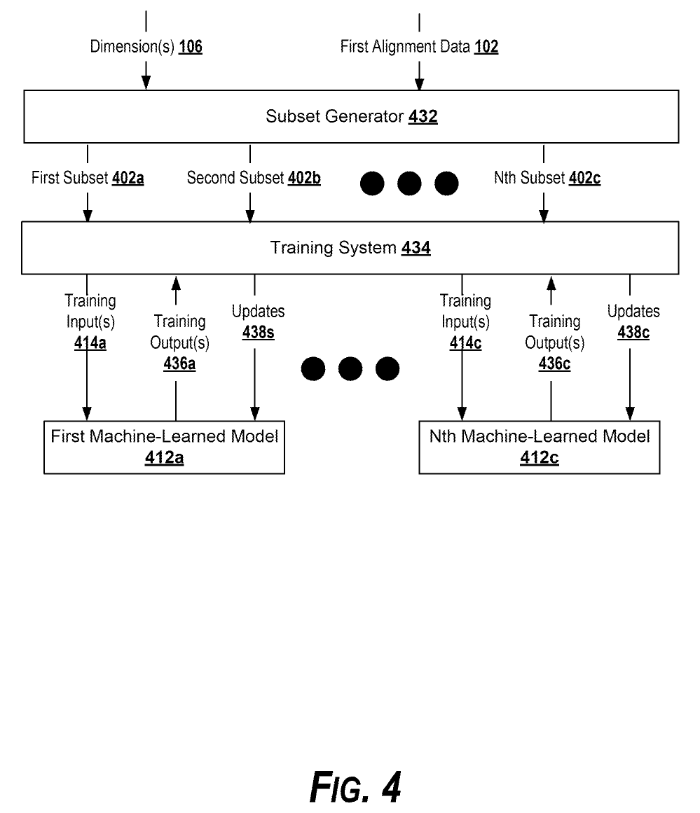

In some instances, a computing system can cause the machine-learned model 112 to generate aligned outputs 116 based on second alignment data 110 in various ways. For example, in some instances, a computing system can select, based at least in part on the second alignment data 110, a first machine-learned model 112 from a plurality of machine-learned models 112, wherein the first machine-learned model 112 has been trained (e.g., fine-tuned, etc.) based on training data that is aligned with one or more dimension-specific preferences expressed in the second alignment data 110. Further details of an example system for training a plurality of aligned models associated with a plurality of distinct second alignment data 110 configurations are provided below with respect to FIG. 4.

As another example, in some instances, a computing system can provide, to a machine-learned model 112 (e.g., general-purpose machine-learned model, pretrained machine-learned model, model fine-tuned for generating aligned outputs based on inputs comprising second alignment data 110, etc.), data (e.g., in-context learning data, etc.) comprising second alignment data 110 to cause the machine-learned model 112 to generated aligned output(s) 116.

In some instances, causing, based on second alignment data 110, a machine-learned model 112 to generate aligned outputs 116 can include some combination of the above-described techniques, or one or more other techniques. For example, in some instances, a plurality of fine-tuned machine-learned models can be trained based on a set of second alignment data 110 configurations that may be smaller than a set comprising all possible second alignment data 110 configurations. For example, in some instances, a subset comprising one or more most common second alignment data 110 configurations can be selected, and a separate machine-learned model 112 can be fine-tuned for each of the subset of common configurations. As another example, in some instances, a subset of dimensions 106 can be selected, and a plurality of machine-learned models 112 can be trained for each of a plurality of second alignment data 110 configurations on the selected dimensions 106 (e.g., without regard to dimension(s) 106 that are not part of the selected subset, etc.). In some instances, for any preference, configuration, or dimension 106 for which a specialized machine-learned model 112 has not been fine-tuned, in-context learning data or other second alignment data 110 can be provided as input to a machine-learned model 112 (e.g., general-purpose machine-learned model 112, specialized machine-learned model associated with one or more fine-tuned alignment preferences, etc.) to cause the machine-learned model 112 to generate aligned inference output(s) 116.

In some instances, a general-purpose machine-learned model 112 configured to generate aligned outputs 116 based on input second alignment data 110 can include a model that has been trained (e.g., fine-tuned, etc.) based on alignment data 102, 110, or a model that has not been fine-tuned based on alignment data 102, 110. For example, in some instances, a general-purpose model can be fine-tuned (e.g., using training examples comprising alignment data 102, 110 inputs, etc.) to generate aligned outputs 116 based on inputs comprising alignment data 102, 110 (e.g., specialized tokens representing individualized second alignment data 110 preferences on one or more dimension(s) 106; natural language data comprising a request to align an inference output with one or more preferences; in-context learning data described below with respect to FIG. 5; etc.), and the general-purpose (e.g., multi-alignment-configuration, etc.) fine-tuned machine-learned model 112 can be provided with second alignment data 110 and input(s) 114 to cause the model 112 to generate aligned outputs 116.

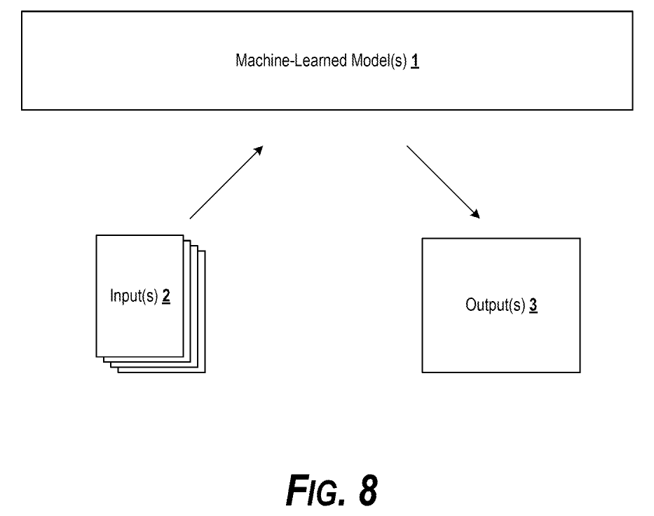

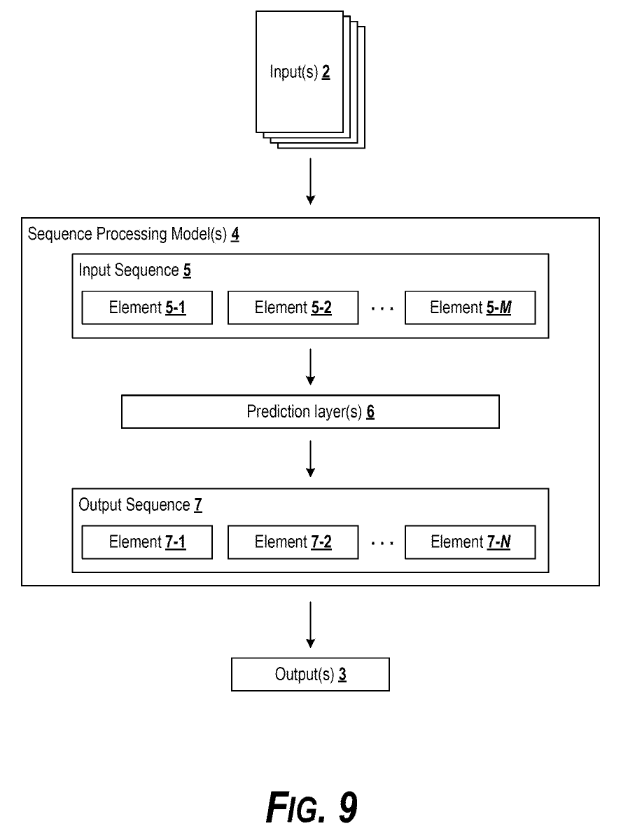

An input 114 can generally include or otherwise represent various types of data. An input 114 can include one type or many different types of data. Example data types for an input 114 can include, for example, any data type described below with respect to FIGS. 8-9 and inputs 2, such as language data (e.g., natural language data such as text or speech data, programming language data, etc.), sequence data (e.g., language sequence, time series, etc.), image data, audio data, video data, or another data type.

An aligned output 116 can generally include or otherwise represent various types of data. An aligned output 116 can include one type or many different types of data. An aligned output 116 can include one or more data types that are similar to (e.g., same as) or different from one or more data types of an input 114. Example data types for an aligned output 116 include, for example, any data type described below with respect to FIGS. 8-9 and inputs 2, such as language data (e.g., natural language data such as text or speech data, programming language data, etc.), sequence data (e.g., language sequence, time series, etc.), image data, audio data, video data, or another data type. As a non-limiting illustrative example, in some instances, an aligned output 116 can include a multimodal output comprising one or more (e.g., both) of text data and image data.

In some instances, an aligned output 116 can include, for example, an output 116 that conforms to one or more individualized dimension-specific preferences of the second alignment data 110. For example, in some instances, an aligned output 116 can include an output having a magnitude with respect to one or more dimension(s) 106, or a position on the one or more dimension(s) 106, that conforms to one or more individualized dimension-specific preferences of the second alignment data 110. A magnitude of an output with respect to a dimension 106 or a position on the dimension 106 can include, for example, a magnitude of an orthogonal projection of a value associated with the output (e.g., embedding of the output in an embedding space used to determine dimension(s) 106, etc.) onto the dimension 106. In some instances, an output 116 that conforms to a dimension-specific preference can include an output 116 that is closer to a preferred position on a dimension 106 compared to a reference output (e.g., reference output generated by a general-purpose machine-learned model 112 that is not provided with second alignment data 110 or is provided with neutral second alignment data 110; reference output generated by a machine-learned model 112 based on second alignment data 110 indicative of a different preference that is different from (e.g., opposite of, etc.) the dimension-specific preference; etc.); an output 116 having a magnitude with respect to a dimension 106 that is higher or lower (e.g., according to a dimension-specific preference) than a magnitude of a reference output; an output that is closer to a preferred position on a dimension 106 compared to a reference metric (e.g., average position of a plurality of reference outputs, etc.); or the like. As a non-limiting illustrative example, an aligned output 116 generated based on second alignment data 110 indicative of a strong preference for concise outputs can include an output that is more concise than a reference output generated based on second alignment data 110 indicative of a preference for verbose outputs, or more concise than an average associated with a plurality of outputs. As another example, an aligned output 116 generated based on second alignment data 110 indicative of a preference for moderately concise outputs can include an output that is more concise than a reference output generated based on second alignment data 110 indicative of a preference for verbose outputs, and less concise than a reference output generated based on second alignment data 110 indicative of a preference for extremely concise (e.g., one-word, etc.) outputs.

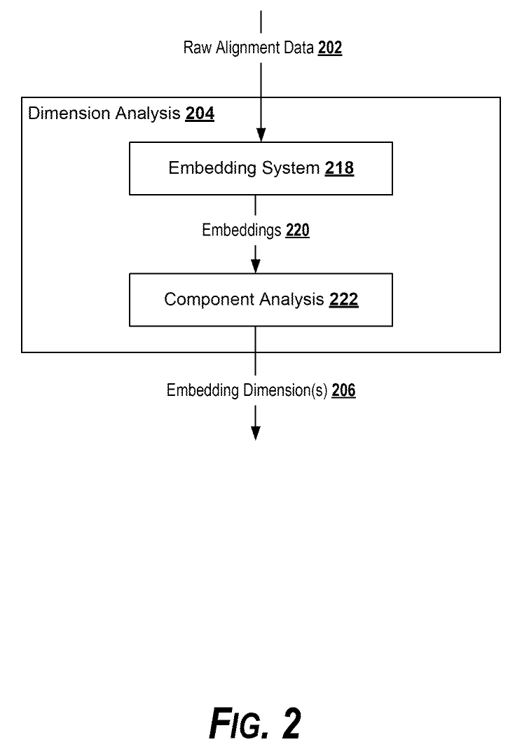

FIG. 2 is a block diagram illustrating an example system for analysis of alignment data according to example implementations of aspects of the present disclosure. A dimension analysis system 204 can obtain raw alignment data 202. Based on the raw alignment data 202, an embedding system 218 of the dimension analysis system 204 can generate a plurality of embeddings 220 associated with a plurality of raw alignment data 202 examples. A component analysis system 222 can perform component analysis on the plurality of embeddings 220 to identify one or more embedding dimension(s) 206 of interest.

In some instances, raw alignment data 202 or embedding(s) 220 can be, comprise, be comprised by, or otherwise share one or more properties with first alignment data 102. For example, in some instances, raw alignment data 202 or embedding(s) 220 can have any property described herein with respect to first alignment data 102, and vice versa. In some instances, raw alignment data 202 can include data that has not yet been processed according to one or more processing methods, such as data that has not yet been embedded by an embedding system 218; data that has not yet been compiled, averaged, or the like; or other raw data.

In some instances, a dimension analysis system 204 can be, comprise, be comprised by, or otherwise share one or more properties with a dimension analysis system 104. For example, in some instances, a dimension analysis system 204 can have any property described herein with respect to a dimension analysis system 104, and vice versa.

In some instances, an embedding dimension 206 can be, comprise, be comprised by, or otherwise share one or more properties with a dimension 106. For example, in some instances, an embedding dimension 206 can have any property described herein with respect to a dimension 106, and vice versa. In some instances, an embedding dimension 206 can include a dimension 106 associated with an embedding space (e.g., machine-learned embedding space, vector space, etc.) associated with the embedding system 218.

An embedding system 218 can be or include one or more software, firmware, or hardware components configured to generate embeddings 220 (e.g., machine-learned embeddings, embedding vectors, etc.) based on raw alignment data 202. In some instances, the embedding system 218 can be a component of a dimension analysis system 204, or can be, comprise, be comprised by, or share one or more properties with a dimension a computing device or system described below with respect to FIGS. 14-16 (e.g., computing device 50, third-party system 80, computing device 98, computing device 99, etc.).

In some instances, an embedding system 218 can include one or more machine-learned models, such as machine-learned embedding models configured to output an embedding 220 (e.g., embedding vector, etc.) based on one or more inputs. An embedding model can include, for example, a sentence embedding model; a document embedding model; or other embedding model (e.g., first few layers of a generative machine-learned model such as machine-learned model 112, paragraph embedding model, etc.). In some instances, an embedding system 218 can include a machine-learned model configured to generate embeddings based at least in part on feedback data associated with the raw alignment data 202, or without regard to such feedback data. For example, in some instances, an embedding system 218 can include a machine-learned model configured to generate an embedding based solely on one or more inference input(s) (e.g., natural language inputs, text inputs, audio inputs, video inputs, etc.), or a machine-learned model configured to generate an embedding based on a combination of inference input(s) and corresponding feedback data associated with the inference input(s). In some instances, an embedding system 218 can generate embeddings 220 using one or more layers of a machine-learned model 112 that will be used to generate aligned outputs 116, such as a first N layers of the machine-learned model 112, where N is a positive integer (e.g., between 1 percent and 99 percent of a total number of layers of the machine-learned model 112, such as between 5 and 95 percent, such as between 20 and 80 percent, such as between 40 and 60 percent, etc.). Other implementations are possible.

Embeddings 220 can include, for example, data (e.g., vector data; n-entry vector of numerical values, where n is a positive integer; values associated with a machine-learned embedding space; etc.) generated by an embedding system 218 based on raw alignment data 202. In some instances, an embedding 220 can include an n-entry vector of numerical values, such as a vector of n magnitudes in n respective basis directions of a position of a raw alignment data 202 input in an embedding space of the embedding system 218. In some instances, a data type for representing an embedding 220 can include a tensor (e.g., one-dimensional “vector” tensor, matrix, etc.) of numerical values, such as a vector of magnitudes of the embedding 220 in a plurality of basis directions associated with an embedding space of the embedding system 218.

In some instances, an embedding 220 can include an embedding generated based on one raw alignment data 202 item, or on multiple raw alignment data 202 items. For example, in some instances, raw alignment data 202 can include one or more pairs of related outputs (e.g., outputs generated based on a shared input; outputs comprising a first draft output and a second draft output generated in response to an edit request; etc.), and an embedding 220 can include a combined embedding generated based on both outputs of the pair. As another example, in some instances, an embedding 220 can include a combined embedding generated from a user input and corresponding generated output; a generated output and corresponding user feedback input; or other combination of related items. In some instances, an embedding 220 can include a combined embedding associated with a plurality of raw alignment data 202 data examples, such as a user embedding generated based on a plurality of data examples associated with a user (e.g., average-pooled embedding generated based on a plurality of data example embeddings, etc.). In some instances, a multi-item combined embedding can include a difference (e.g., difference determined using vector arithmetic such as subtraction) between two embedding values; a single combined machine-learned embedding generated by providing a first data item and one or more second data items to a machine-learned embedding model; or other combination of embeddings (e.g., average-pooled combination, summed embeddings, etc.).

In some instances, a component analysis system 222 can be, comprise, be comprised by, or otherwise share one or more properties with a dimension analysis system 104. For example, in some instances, a component analysis system 222 can have any property or perform any action described herein with respect to a dimension analysis system 104, and vice versa.

For example, in some instances, identifying embedding dimension(s) 206 based on embeddings 220 can include one or more of: evaluating each of a plurality of candidate embedding dimensions based on one or more metrics of relevance (e.g., variance, correlation, covariance, independence, between-user variance, within-user variance, user-blind variance, PCA-related metric, ICA-related metric, factor analysis-related metric, mutual information, entropy, divergence, Gaussianity, kurtosis, negentropy, singular value, etc.); ranking dimensions according to a metric of relevance and selecting one or more dimension(s) 106 based on the ranking (e.g., top k ranked dimensions, etc.); dimensionality reduction (e.g., principal component analysis (PCA), singular value decomposition, etc.); independent component analysis; factor analysis; or other component analysis method.

For example, in some instances, identifying embedding dimension(s) 206 based on embeddings 220 can include performing component analysis 222 (e.g., principal component analysis, factor analysis, independent component analysis, etc.) on a tensor (e.g., matrix, etc.) of machine-learned embeddings 220 of the first alignment data 102.

FIG. 3 is a block diagram illustrating an example system for obtaining targeted alignment feedback based on dimensional analysis of alignment data according to example implementations of aspects of the present disclosure. An alignment system 308 can obtain data indicative of one or more dimensions 106 of interest. Based on the dimension(s) 106, a query determination system 324 of the alignment system 308 can determine (e.g., generate, select, etc.) one or more queries 326. The alignment system 308 can provide the one or more queries 326 to one or more users 328, and can receive one or more alignment inputs 330 from the user(s) 328. Based on the alignment input(s) 330, the alignment system 330 can determine second alignment data 110, which can be used to cause a machine-learned model 112 to generate output(s) 116 consistent with the alignment inputs 330.

In some instances, an alignment system 308 can be, comprise, be comprised by, or otherwise share one or more properties with an alignment system 108. For example, in some instances, an alignment system 308 can have any property described herein with respect to an alignment system 108, and vice versa.

A query determination system 324 can be or include one or more software, firmware, or hardware components configured to determine (e.g., generate, select, retrieve, etc.) one or more queries 326 based on one or more dimensions 106. In some instances, the query determination system 324 can be a component of the alignment system 308, or can be, comprise, be comprised by, or share one or more properties with a computing device or system described below with respect to FIGS. 14-16 (e.g., computing device 50, third-party system 80, computing device 98, computing device 99, etc.).

A query 326 can include, for example, any output (e.g., natural language output, computer code output, hypertext transfer protocol request, graphical user interface component, etc.) configured to request alignment inputs 330 or to cause a user 328 or other entity to provide alignment inputs 330. For example, in some instances, a query can include a natural language question associated with a dimension 106 (e.g., “Would you prefer outputs that are more concise or more verbose?” etc.). As another example, in some instances, a query can include one or more example inference outputs, with a request to evaluate the example inference output(s) (e.g., provide a rating on a scale of one to ten; select a favorite among a plurality of example inference outputs; etc.). As a non-limiting illustrative example, in some instances, a query can include a plurality of example inference outputs associated with a plurality of positions on a dimension 106; a natural language description of the dimension 106; a label (e.g., natural language label such as “most concise:”, “somewhat concise:”, “average”, etc.) for each of the plurality of example inference outputs; a request to select a preference with respect to the dimension 106; and one or more input components (e.g., buttons, checkboxes, radio buttons, etc.) for selecting a preferred inference output. As another example, in some instances, a query 326 can include or be included in an open-ended interface for optionally inputting preferences associated with each of a plurality of dimension(s) 106 (e.g., optionally providing feedback with respect to any one or more of a plurality of data examples; optionally answering any one or more of a plurality of questions; etc.).

In some instances, determining a query 326 can include generating the query 326 based at least in part on a dimension 106. For example, in some instances, generating a query 326 based on a dimension 106 can include selecting one or more data examples associated with alignment data 102, 202, 110 based on the dimension 106, and generating a query 326 based on the data examples. In some instances, selecting one or more data examples can include selecting based on an orthogonal projection (e.g., dot product, etc.) of embedding(s) of the data example(s), such as by selecting a top x data examples having a largest-magnitude orthogonal projection or a top y data examples having a smallest-magnitude orthogonal projection (or a largest-magnitude orthogonal projection on an inverse of the dimension 106, etc.), wherein x and y can be the same positive integer or different positive integers. As another example, in some instances, selecting one or more data examples can include selecting based on an angular difference between the dimension 106 and an embedding of the data examples, such as by selecting a top x data examples having a smallest cosine distance from the dimension 106 or a top y data examples having a smallest cosine distance from an inverse of the dimension 106. For example, in some instances, a machine-learned model (e.g., sequence processing model, language model, etc.) can be provided with one or more data examples having a highest-magnitude orthogonal projection; one or more data examples having a lowest-magnitude orthogonal projection; and an instruction to explain what property or properties the highest-magnitude data examples may have in common, which the lowest-magnitude examples may lack (or what preference(s) might be satisfied by the highest-magnitude examples and not by the lowest-magnitude examples, etc.). Other instructions (e.g., “Please generate a user question that would help distinguish users who prefer the first group of outputs from users who prefer the second group of outputs.”, etc.) or in-context learning content (e.g., few-shot examples, chain-of-thought examples, etc.) are possible. In some instances, a set of one or more data examples can include data examples having a diverse range of positions on dimension(s) 106 other than a dimension 106 for which a query 326 that is being generated, although this is not required. Additionally, machine-learned query 326 generation is not required. For example, in some instances, generating a query 326 based on data examples can include merely selecting a plurality of data examples (e.g., data examples located at approximately evenly spaced positions on a spectrum of positions on the dimension 106, etc.) to provide to the user; and providing the plurality of data examples to the user, along with an interface for selecting a preference (e.g., preferred data example, preferred position with respect to the dimension 106, etc.) associated with the plurality of data examples.

As another example, in some instances, generating a query 326 can include generating the query 326 without reference to any first alignment data 102, 202, such as by generating a query 326 based directly on a dimension 106 (e.g., by providing a vector defining the dimension in an embedding space to a decoder-only machine-learned model configured to decode embedding vectors of the embedding space, etc.); by generating example inference outputs based on the dimension 106 (e.g., without reference to first alignment data 102, etc.); or in another manner.

In some instances, determining a query 326 can include operations other than generating the query 326, such as retrieving a query 326 that has already been generated; selecting a query 326 from a plurality of available queries; or the like.

A query 326 can generally include or otherwise represent various types of data. A query 326 can include one type or many different types of data. Example data types for a query 326 can include, for example, any data type described below with respect to FIGS. 8-9 and outputs 3, such as language data (e.g., natural language data such as text or speech data, programming language data, etc.), sequence data (e.g., language sequence, time series, etc.), image data, audio data, video data, or another data type. As a non-limiting illustrative example, in some instances, a query 326 can include at least text data (e.g., natural language text data, etc.) and image data. Continuing the non-limiting illustrative example, in some instances, a query 326 can include text data comprising a natural language description of a dimension 106 and one or more example images associated with the dimension 106, such as a set of example images comprising one or more of: a top x images with a highest magnitude dot product with the dimension 106, where x can be a positive integer; a top y images with a lowest magnitude (e.g., most negative magnitude, lowest absolute value, etc.) dot product with the dimension 106, where y can be a positive integer; a plurality of examples having a range of dot product magnitudes (e.g., k images each of top, bottom, 25^{th} percentile, 50^{th} percentile, and 75^{th} percentile magnitudes, etc.). Other examples are possible.

In some instances, determining a query 326 can include determining a query 326 based at least in part on a group or cluster, such as a group of users (e.g., organization, etc.), cluster of users, inputs, topics, or other values; or the like. For example, in some instances, determining a query 326 can include identifying a user group associated with a user 328 (e.g., determining a cluster assignment for the user based on prior feedback inputs from the user; based on prior inference request inputs from the user; based on user data such as organization membership, account preferences, access permission data, or other data); and determining a query 326 based on a set of group-specific dimension(s) 106 associated with the group (e.g., group-specific dimension(s) 106 determined as described above with respect to FIG. 1, etc.). As another example, in some instances, determining a query 326 can include identifying a cluster (e.g., semantic cluster, embedding cluster, topic cluster, etc.) associated with an inference input provided by a user 328; and determining a query 326 based on a set of cluster-specific dimension(s) 106 associated with the cluster (e.g., cluster-specific dimension(s) 106 determined as described above with respect to FIG. 1, etc.). In some instances, a user or input 114 may belong to one group or cluster, or multiple groups or clusters. In some instances where a user or input 114 belongs to multiple groups or clusters, a set of queries 326 provided to a user can include queries 326 based on dimension(s) 106 associated with one group or multiple groups, such as dimension(s) 106 of a highest-priority group; all relevant dimension(s) 106; or other set of dimensions 106. In some instances, a set of queries 326 can include one or more queries generated based on group-specific dimension(s) 106, and one or more queries based on non-group-specific dimension(s) 106.

In some instances, an input-specific query 326 can be determined based at least in part on an input 114 associated with an inference to be performed by a machine-learned model 112 (e.g., in order to obtain second alignment data 110 before performing a machine-learned inference based on the input 114, etc.). For example, in some instances, a computing system can receive an input 114; select, based on the input 114, one or more dimensions 106 (e.g., one or more dimensions 106 having particular relevance to the input 114, etc.) of a plurality of possible dimensions 106 (e.g., of a set of dimensions 106 determined according to methods described above with respect to FIG. 1, etc.); determine, based on the one or more selected dimensions 106, a query 326 to provide to the user; receive, from the user 328, alignment inputs 330 associated with the selected dimension(s) 106; and generate an inference output based on the input 114 and second alignment data 110 associated with the selected dimension(s) 106.

In some instances, selecting one or more dimensions based on an input 114 can include selecting based on one or more conditional probabilities associated with the input 114. For example, in some instances, a first output distribution (e.g., conditional probability distribution, etc.) can be generated based on a first configuration of second alignment data 110, such as a reference distribution generated based on neutral alignment data 110 or generated without providing second alignment data 110. Continuing the example, a second output distribution (e.g., conditional probability distribution, token output distribution, etc.) can be generated based on a second configuration of alignment data, and an evaluation metric (e.g., metric of difference between the distributions such as Kullback-Leibler divergence, etc.) can be evaluated. In some instances, a plurality of respective difference metrics associated with a plurality of respective dimensions 106, and a dimension 106 with a high (e.g., highest, etc.) difference metric can be identified as a dimension 106 for which an output is sensitive (e.g., most sensitive) to user preferences along the dimension 106 or for which collecting second alignment data 110 is otherwise valuable. In some instances, dimensions 106 can be evaluated based on one or more other properties, such as a metric of covariance or correlation between a conditional probability distribution and user preference data along the dimension(s) 106; a metric (e.g., estimate, etc.) of between-user variance in preference given the input 114; a metric of variance along the dimension(s) 106 of a conditional output distribution conditioned on the input 114; or the like. In some instances, the dimensions 106 can be ranked, and a top q dimensions 106 can be selected based on the ranking, where q can be a positive integer (e.g., one, etc.). In some instances, a difference metric or other metric can be compared to a threshold, and second alignment data 110 can be collected for each dimension 106 that exceeds the threshold. Other implementations are possible.

In some instances, one or more dimensions 106 or queries 326 can be selected according to a precomputed decision tree or other precomputed data. For example, in some instances, a plurality of inputs 114 can be analyzed to determine a plurality of corresponding preferred dimension(s) 106 or preferred queries associated with the inputs 114, and a plurality of input 114 – query 326 or input 114 – dimension 106 tuples (e.g., pairs, etc.) can be used to learn a lightweight decision process, such as a decision tree or other learned process (e.g., lightweight multilayer perceptron having a much smaller number of parameters compared to a machine-learned model 112, k nearest neighbor, random forest, etc.).

In some instances, selecting one or more dimensions based on an input 114 can include machine-learned selection. For example, in some instances, the input 114 can be provided to a machine-learned model (e.g., lightweight machine-learned model having a reduced computational cost, latency, parameter count, or the like compared to a machine-learned model 112, etc.), along with in-context learning content configured to cause the machine-learned model to select one or more dimensions 106 from a set of dimensions 106 (e.g., “Based on the following user request, please determine what user preference data must be collected in order to best satisfy the user request according to the user’s preferences, which may not be expressly described in the request. Your output should include an ordered ranking of the following user preference dimensions” followed by a list of natural language dimension descriptions generated based on a set of dimensions 106, etc.), and the one or more dimensions can be selected based on an output of the machine-learned model. Other examples are possible (e.g., using fine-tuned model, etc.).

A user 328 can include, for example, an entity (e.g., person, etc.) from which a computing system can obtain (e.g., receive, etc.) one or more alignment inputs 330. Although FIG. 3 depicts a “user” 328, alignment inputs 330 can be obtained from other entities (e.g., computing systems, organizations, machine-learned agents, etc.) without deviating from the scope of the present disclosure.

Alignment input(s) 330 can include, for example, any input indicative of second alignment data 110 (e.g., indicative of individualized dimension-specific preferences such as user-specific preferences associated with a dimension 106), such as one or more graphical user interface interactions (e.g., button clicks, text box inputs such as numerical inputs, natural language inputs such as text or audio inputs, etc.) indicative of a response to a query 326; one or more application programming interface (API) inputs; or other inputs.

In some instances, second alignment data 110 can include raw alignment input(s) 330, or data derived from alignment input(s) 330, such as statistical aggregate data generated from a plurality of inputs; structured or formatted data generated based on unstructured inputs 330; or other second alignment data 110.

FIG. 4 is a block diagram illustrating an example system for training a plurality of machine-learned models to generate aligned inference outputs based on alignment data according to example implementations of aspects of the present disclosure. Based on one or more dimensions 106 of interest and first alignment data 102, a subset generator 432 can generate alignment data subsets 402 associated with a plurality of alignment preferences with respect to the dimension(s) 106. Based on each respective subset 402 of the plurality of subsets 402, a training system 434 can train a respective machine-learned model 412 of a plurality of machine-learned models 412 based on the respective subset 402. Training a machine-learned model can include, for each of a plurality of training iterations: providing one or more training inputs 414 from a respective subset 402 to the respective machine-learned model 412; receiving, from the respective machine-learned model 412, one or more training outputs 436 based on the input(s) 414; and providing, to the respective machine-learned model 412, one or more updates 438a based on the training output(s) 436.

In some instances, an alignment data subset 402 can be, comprise, be comprised by, or otherwise share one or more properties with first alignment data 102. For example, in some instances, an alignment data subset 402 can have any property described herein with respect to first alignment data 102, and vice versa. In some instances, a plurality of alignment data subsets 402 can be a plurality of subsets of a data set of first alignment data 102. In some instances, each subset 402 can be associated with a distinct combination of one or more respective alignment preferences associated with one or more respective dimensions 106. As a non-limiting illustrative example, a set of dimensions 106 can include P dimensions 106. For each of the P dimensions 106, Q ranges of positions along the dimension 106 can be defined. And for each of P^{Q} possible combinations of ranges on the P dimensions, a subset 402 can be defined, wherein the subset 402 can include some (e.g., all, etc.) first alignment data 102 data examples that fall within each range of the respective combination of ranges. For example, in some instances, an embedding value can be obtained (e.g., generated, retrieved from a data structure, received from another computing device, etc.) for each data example of the first alignment data 102. Continuing the example, in some instances, each embedding value can be orthogonally projected onto each of one or more dimensions 106, and a magnitude of the orthogonal projection can be determined. Additionally or alternatively, in some instances, another evaluation value can be determined based on each of the dimension(s) 106, such as an angular difference between the dimension 106 and embedding value or other evaluation. Continuing the example, in some instances, the magnitudes of each of P orthogonal projections of the embedding value onto the P dimensions can fall within a range (e.g., one of Q ranges, etc.) of the relevant dimension, and the combination of magnitudes can fall within one of P^{Q} possible combination of ranges. Other implementations are possible.

A training input 414 can generally include or otherwise represent various types of data. A training input 414 can include one type or many different types of data. Example data types for a training input 414 can include, for example, any data type described below with respect to FIGS. 8-9 and inputs 2, such as language data (e.g., natural language data such as text or speech data, programming language data, etc.), sequence data (e.g., language sequence, time series, etc.), image data, audio data, video data, or another data type.

In some instances, a training input 414 can be, comprise, be comprised by, or otherwise share one or more properties with an input 114. For example, in some instances, a training input 414 can have any property described herein with respect to an input 114, and vice versa.

In some instances, a training input 414 can include an input associated with a data example of a subset 402 associated with the training input 414. For example, a training input 414a for training a first machine-learned model 412a can include an input associated with a data example of a first subset 402a; a training input 414 for training a second machine-learned model can include an input associated with a data example of a second subset 402b; a training input 414c for training an Nth machine-learned model 412c can include an input associated with a data example of an Nth subset 402c; and so on, where N can be a positive integer.

In some instances, a training input 414 can include or not include alignment data 110. For example, in some instances, training (e.g., fine-tuning) methods described herein with respect to FIG. 4 can be used alone or in combination with prompting (e.g., in-context learning, etc.) methods described herein with respect to FIG. 5. As a non-limiting illustrative example, in some instances, a first set of dimensions 106 (e.g., a first subset of a set of dimensions 106 identified according to FIG. 1) can be used to generate subsets 402, and each machine-learned model 412 can be trained using inputs 414 associated with a respective subset 402 associated with the machine-learned model 412, wherein the training inputs 414 include in-context learning data (e.g., as described below with respect to FIG. 5, etc.) associated with a second set of dimensions 106 that is different from (e.g., completely disjoint from, partially overlapping, etc.) the first set of dimensions 106. In this manner, for instance, a plurality of machine-learned models 412 can be trained to align with a first set of individualized preferences on the first set of dimensions without requiring inputs 114, 414 indicative of the dimensions, and can be trained (e.g., fine-tuned, etc.) to flexibly generate aligned outputs 116 that are aligned with a second set of individualized preferences on the second set of dimensions 106 based on inputs indicative of the individualized preferences. Other implementations are possible. For example, in some instances, a single machine-learned model can be trained (e.g., according to training methods described herein with respect to FIG. 4) to generate aligned outputs 116 based on training inputs 414 comprising data indicative of individualized preference(s) on dimension(s) 106 (e.g., in-context learning data 510 as described below with respect to FIG. 5, etc.).

In some instances, a training input 414 can include an input associated with a training example (e.g., first alignment data 102 data example, etc.) comprising an input-output pair (e.g., comprising a ground truth output, etc.), an input-evaluation pair comprising one or more metrics, functions, or other data for evaluating a training output 436 generated based on the input-output pair; or the like. As a non-limiting illustrative example, in some instances, an input-evaluation pair can include input data indicative of an individualized preference associated with a dimension 106, such as data indicative of a preferred position on the dimension 106 (e.g., preferred magnitude of an orthogonal projection of an embedding value onto the dimension 106, etc.), data indicative of a preferred direction (e.g., higher or lower, such as a preference to maximize a magnitude of an orthogonal projection of an embedding value onto the dimension 106, etc.), or other individualized preference data. Continuing the non-limiting illustrative example, in some instances, an input-evaluation pair can include (e.g., further include, etc.) a metric, function, or other data for evaluating a degree to which a training output 436 aligns with the individualized preference. For example, in some instances, an evaluation metric for evaluating an alignment of a training output 436 with a preferred position on a dimension 106 can include or be based on, for example, a metric of difference (e.g., absolute value of arithmetic difference between scalars, Euclidean distance between vectors, cosine distance between vectors, etc.) between a value associated with a training output 436 (e.g., magnitude of an orthogonal projection of an machine-learned embedding value generated from the training output 436 onto a dimension 106) and a preference value (e.g., preferred magnitude, etc.). In some instances, an evaluation function can include an objective function (e.g., reward function, loss function, etc.) that rewards or penalizes training outputs 436 based on an alignment (e.g., cosine distance, magnitude of orthogonal projection, etc.) between the training output 436 and the dimension 106. For example, in some instances, training a machine-learned model 112 can include reinforcement learning, wherein a reward signal (e.g., objective function) evaluated at each iteration of the reinforcement learning process can include an aggregation (e.g., sum, average, product, etc.) of one or more (e.g., a plurality of) reward signals associated with each of a plurality of individualized preference values (e.g., values used to generate a subset 402, values provided as training input(s) 414, etc.) on each of a plurality of dimensions 106.

A subset generator 432 can be or include one or more software, firmware, or hardware components configured to generate subset(s) 402 from first alignment data 102 based on dimension(s) 106. In some instances, the subset generator 432 can be, comprise, be comprised by, or share one or more properties with a computing device or system described below with respect to FIGS. 14-16 (e.g., computing device 50, third-party system 80, computing device 98, computing device 99, etc.).

In some instances, generating a plurality of subsets 402 can include, for example, defining a plurality of ranges for each of one or more dimensions 106; identifying, for each data example of first alignment data 102, and along each respective dimension of the one or more dimensions 106, which range of the plurality of ranges of the respective dimension the data example falls into; and assigning the data example to a subset 402 based on the identified range(s). In some instances, a range can include a range of possible magnitudes of an orthogonal projection of an embedding value onto a dimension 106; a range of possible cosine distances or other metrics of distance between an embedding value and a vector indicative of the dimension 106; or the like. In some instances, a set of dimensions 106 used to generate the subsets 402 can include group-specific dimension(s) 106 (e.g., as described above with respect to FIGS. 1-3); non-group-specific dimension(s) 106; or both.

A training system 434 can be or include one or more software, firmware, or hardware components configured to provide training inputs 414 to and receive training outputs 436 from machine-learned models 412, and to provide updates 438 to the machine-learned models 412 based on an evaluation of the training outputs 436. In some instances, the training system 434 can be, comprise, be comprised by, or share one or more properties with a computing device or system described below with respect to FIGS. 14-16 (e.g., computing device 50, third-party system 80, computing device 98, computing device 99, etc.). In some instances, the training system 434 can include a device or component that is the same as or different from a device or component associated with the subset generator 432.

In some instances, a training output 436 can be, comprise, be comprised by, or otherwise share one or more properties with an aligned output 116. For example, in some instances, a training output 436 can have any property described herein with respect to an aligned output 116, and vice versa. In some instances, a training output 436 can include an output that is aligned or not aligned with one or more individualized preferences associated with a subset 402 or input 414. For example, during a plurality of training iterations, a machine-learned model 412 is likely to generate some training outputs 436 that are aligned with individualized preferences on one or more dimensions 106 (e.g., preference values used to generate a subset 402, preference values provided as training inputs, 414, etc.), and some training outputs 436 that are not aligned with individualized preferences on the dimension(s) 106. In the training iterations, the training outputs 436 can be evaluated for alignment, and an update 438 can be determined based at least in part on a metric of alignment of the training outputs 436 with one or more individualized preferences on one or more dimensions 106.

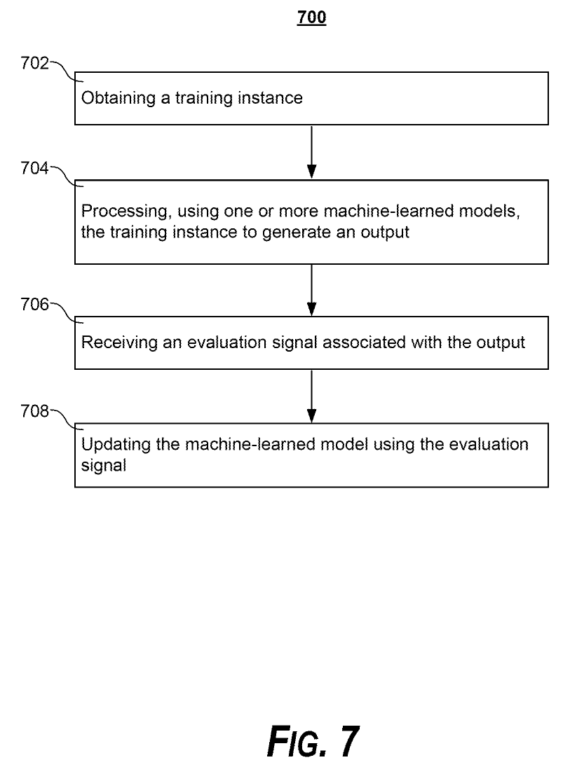

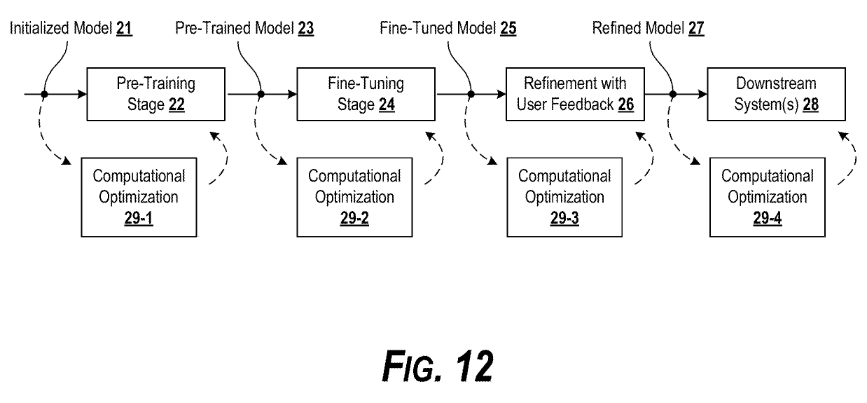

A model update 438 can include, for example, a value (e.g., numerical value, etc.) for updating one or more parameters of the machine-learned model 412, an action for updating the machine-learned model 412, or the like. For example, in some instances, a model update 438 value can include a numerical adjustment value to be combined with (e.g., added to, multiplied by, etc.) a parameter of the machine-learned model 412 to generate an updated parameter. In some instances, a model update 438 can be determined based on an evaluation of a training output 436, such as evaluation using a loss function, reward function, or other objective function. For example, in some instances, a training output 436 can be compared to one or more individualized preferences on one or more dimensions according to an objective function (e.g., loss function, reward function, etc.), or compared to a ground truth output according to a loss function, or evaluated in another manner. In some instances, a gradient of an objective function with respect to one or more training outputs 436 (e.g., mini-batch comprising a plurality of loss values associated with a plurality of training outputs 436, etc.) can be determined, and the model updates 438 can be determined based on one or more gradients (e.g., by multiplying the gradient by a constant or adaptive learning rate parameter, etc.). Further details of some example methods for updating a machine-learned model are provided below, such as with respect to FIGS. 7 and 12.

In some instances, an objective function for determining one or more updates 438 can include an objective function determined based on a comparison between a training output 436 and each of one or more individualized preference values (e.g., values used to generate a respective subset 402 used to train a corresponding machine-learned model 412, values provided as training inputs 414, etc.) associated with one or more dimensions 106. For example, in some instances, an objective function can include an aggregation (e.g., sum, average, product, etc.) of a plurality of dimension-specific evaluation metrics associated with each of a plurality of dimensions 106, along with zero or more other values (e.g., values indicative of factual correctness, reasoning accuracy, or other evaluation values associated with a training output 436). For example, in some instances, evaluating an objective function with respect to a training output 436 can include evaluating, for each dimension 106 of a set of dimensions 106 (e.g., a set of dimensions 106 identified according to FIG. 1, a set of dimensions 106 for which preference data is known or provided, etc.), an alignment of the training output 436 with a given preference value associated with that dimension. In some instances, a dimension-specific evaluation metric can include a magnitude of an orthogonal projection of a value associated with the training output 436 (e.g., machine-learned embedding of the training output 436 in an embedding space used to identify the dimensions 106 according to FIG. 1, etc.), such as in instances where a dimension-specific preference is to maximize an alignment with the dimension 106. Similarly, in some instances (e.g., instances where a preference is to minimize an orthogonal projection, etc.) an evaluation metric can include an inverse (e.g., additive inverse, etc.) of the magnitude of the orthogonal projection. Similarly, in some instances, a dimension-specific evaluation metric can include a metric of difference (e.g., cosine distance, etc.) between an embedding value associated with the training output 436 and the dimension 106, or an inverse of the metric of difference. Additionally, in some instances, a dimension-specific evaluation metric can include a metric of difference (e.g., difference determined via subtraction of scalar values, etc.) between an orthogonal projection value (e.g., orthogonal projection of an embedding of the training output 436 onto the dimension 106, etc.) and a preferred orthogonal projection value associated with a dimension-specific preference; between a cosine distance value and a preferred cosine distance value associated with a dimension-specific preference; or the like.

In some instances, an objective function for determining one or more updates 438 can include a reward signal associated with a reinforcement learning process, such as a reward signal that rewards outputs that are aligned with relevant individualized preferences or penalizes outputs that are not aligned with the individualized preferences. In some instances, an objective function (e.g., reward signal, etc.) can be evaluated with respect to individual tokens of a training output 436, or with respect to sequences of multiple tokens associated with the training output 436. For example, in some instances, a machine-learned model 412 can include a sequence processing model, and each training output 436 can include a sequence (e.g., natural language sequence, etc.) generated based on a training input 414. In some instances, an entire sequence (e.g., sequence ending in an end-of-sequence (EOS) token, etc.) can be provided to a machine-learned embedding model (e.g., embedding model associated with an embedding space used in identifying dimension(s) 106 according to FIG. 1, etc.) to generate an embedding value associated with the entire sequence, and the embedding value can be used to evaluate an objective function indicative of alignment of the sequence with one or more dimension-specific preference values.

In some instances, a plurality of machine-learned models 412 trained according to methods described in FIG. 4 can be used to generate aligned outputs 116 as depicted in FIG. 1. For example, in some instances, generating an aligned output 116 can include selecting, based on second alignment data 110 comprising one or more dimension-specific preferences, a corresponding machine-learned model 412 that has been trained to generate outputs that are aligned with the one or more dimension-specific preferences.

FIG. 5 is a block diagram illustrating an example system for generating aligned inference outputs based on in-context learning content determined based on alignment data according to example implementations of aspects of the present disclosure. Based on one or more alignment inputs 530, a prompt selection or prompt generation system 540 of an alignment system 508 can determine (e.g., select, generate, etc.) in-context learning data 510. The alignment system 508 can provide the in-context learning data 510 to a machine-learned model 112, and the machine-learned model 112 can generate aligned output(s) 116 based on input(s) 114 and the in-context learning data 510.

In some instances, an alignment system 508 can be, comprise, be comprised by, or otherwise share one or more properties with an alignment system 108. For example, in some instances, an alignment system 508 can have any property described herein with respect to a an alignment system 108, and vice versa.

In some instances, in-context learning data 510 can be, comprise, be comprised by, or otherwise share one or more properties with second alignment data 110 or input(s) 114. For example, in some instances, in-context learning data 510 can have any property described herein with respect to second alignment data 110 or input(s) 114, and vice versa.

In some instances, in-context learning data 510 can include inputs 114 configured to influence an output of the machine-learned model 112, such as inputs 114 configured to cause an output of the machine-learned model 112 to generate aligned outputs 116 that are aligned with one or more individualized dimension-specific preferences associated with one or more dimensions 106 (e.g., group-specific dimensions 106 associated with a specific group or cluster of users; non-group-specific dimensions 106; etc.). In some instances, in-context learning data 510 can include instruction content, such as an instruction to generate an output that satisfies a preferred property (e.g., “Please make sure your answer is <preferred_property>,” wherein <preferred_property> can be replaced with a natural language description of an individualized dimension-specific preference, etc.). In some instances, in-context learning data can include example data, such as one or more example input-output pairs (e.g., few-shot examples, etc.); one or more input-reasoning-output pairs (e.g., chain-of-thought examples, etc.); or other example data. In some instances, in-context learning data can include prompt data configured to cause an aligned output 116 to be aligned with one or more individualized (e.g., user-specific, organization-specific, etc.) dimension-specific preferences, such as few-shot prompting, chain-of-thought prompting, least-to-most prompting, system prompts, user prompts, or other prompt data. In some instances, in-context learning data 510 can include data in a standard format (e.g., natural language, etc.) or data in a structured format (e.g., JSON, XML, etc.) or specialized format (e.g., specialized tokens indicative of one or more dimension-specific preferences, such as VERY_CONCISE token indicative of a preference for extreme conciseness, etc.). In some instances, in-context learning data 510 can include vector content, such as a soft prompt vector that has been optimized (e.g., using fine-tuning, etc.) to cause a machine-learned model 112 to generate aligned outputs 116 that align with a dimension-specific preference; a vector of activation values; or a vector indicative of a one or more dimension-specific preferences. In some instances, in-context learning data 510 can include one or more intermediate activation values to be provided to an intermediate layer of a machine-learned model 112, such as a raw activation value (e.g., constant value, etc.) to be substituted for one or more activations of the intermediate layer; an adjustment value to be combined with (e.g., added to, etc.) one or more activations of the intermediate layer generated based on the inputs 114; or other intermediate activation value.

In some instances, an alignment input 530 can be, comprise, be comprised by, or otherwise share one or more properties with an alignment input 330. For example, in some instances, an alignment input 530 can have any property described herein with respect to an alignment input 330, and vice versa. In some instances, an alignment input 530 can include a stored value indicative of an alignment input 330 received in the past, such as an alignment input 330 received from an entity (e.g., user, computing system, organization, etc.) immediately before receiving an input 114; immediately after receiving an input 114 or providing a query 326; significantly before receiving an input 114 (e.g., upon account creation of a user account, etc.); or at another time.

A prompt selection/generation system 540 can be or include one or more software, firmware, or hardware components configured to select or generate in-context learning data 510 based on one or more alignment inputs 530. In some instances, the prompt selection/generation system 540 can be, comprise, be comprised by, or share one or more properties with a computing device or system described below with respect to FIGS. 14-16 (e.g., computing device 50, third-party system 80, computing device 98, computing device 99, etc.).

In some instances, in-context learning data 510 can be generated using one or more machine-learned models, or in another manner. For example, in some instances, in-context learning data 510 can be determined according to a method similar to (e.g., same as, etc.) one or more methods described above with respect to determining a query 326. For example, in some instances, a dimension 106 vector or one or more first alignment data 102 examples selected based on the dimension 106 can be provided to a machine-learned model (e.g., sequence processing model, language model such as natural language model, machine-learned model 112, etc.), along with in-context learning content (e.g., instruction content, few-shot examples, chain-of-thought examples, etc.) to cause the machine-learned model to output in-context learning data 510 based on the dimension 106 vector or first alignment data 102 examples. Example in-context learning data to cause a machine-learned model (e.g., natural language model, etc.) to generate in-context learning data 510 can include instruction content, such as an instruction to output an appropriate prompt based on the first alignment data 102 example(s) (e.g., “Please analyze the following example outputs, which are labeled BAD and GOOD, and please draft a few prompts to cause a machine-learned model to generate outputs similar to the GOOD example outputs and very different from the BAD example outputs.”, etc.).

In some instances, in-context learning data 510 can include one or more example input-output pairs, such as example input-output pairs contained in the first alignment data 102. For example, in some instances, first alignment data 102 can include a plurality of input-output pairs comprising an input and a corresponding output generated by a machine-learned model based on the input. In some instances, an output of each input-output pair can be compared to a dimension 106, and one or more most-aligned input-output pairs can be selected based on the comparison. For example, in some instances, an output of each input-output pair of a plurality of pairs contained in the first alignment data 102 can be embedded in a machine-learned embedding space (e.g., embedding space used to determine the dimension(s) 106, etc.) to generate an embedding value. Comparing the embedding value to the dimension can include, for example, comparing based on a metric of difference (e.g., cosine distance, etc.) between the embedding value and the dimension 106, based on a magnitude of an orthogonal projection of the embedding value onto the dimension 106, or other comparison.

In some instances, in-context learning data 510 can be determined based on a query 326, alignment input 330, 530, or other data. As a non-limiting illustrative example, in some instances, a query 326 (e.g., natural language query 326, etc.) and alignment input 330 (e.g., natural language alignment input 330, etc.) responsive to the query can be provided to a machine-learned model 112 as input context (e.g., “Your output should comply with the following user preferences the user provided in response to the following preference questions:” followed by one or more query 326-alignment input 330 pairs, etc.). As another example, in some instances, all or part of a query 326 can be added to (e.g., concatenated with, etc.) an in-context learning template to generate in-context learning data 510 (e.g., “Your output should be as _________ as possible,” with the blank filled in using all or part of a query 326 comprising a natural language description of a dimension-specific preference, etc.).

In some instances, in-context learning data 510 can be selected from a plurality of candidate in-context learning data 510 examples, such as by retrieving the selected in-context learning data 510 from a data structure (e.g., database, etc.) comprising in-context learning data 510. For example, in some instances, a plurality of stored in-context learning data 510 examples (e.g., one data example for each of a plurality of combinations of dimension-specific preferences along one or more dimensions 106, etc.) can be determined (e.g., generated according to methods described herein, etc.), and can be stored in one or more data structures (e.g., database(s), table(s), file(s), folder(s), etc.). Continuing the example, upon receiving an input 114 associated with a user 328, or at another time (e.g., upon user 328 login, etc.), in-context learning data 510 can be retrieved from the data structure based on alignment input(s) 530 associated with the user 328, such as stored data indicative of alignment inputs 330 provided by the user 328 upon account creation or at another time (e.g., ad hoc, etc.). For example, a combination of one or more individualized dimension-specific preferences of the user 328 along the dimension(s) 106 can be identified, and one or more in-context learning data 510 examples corresponding to the combination of individualized dimension-specific preference(s) can be retrieved from a data structure based on the preferences. Other implementations are possible.

In some instances, selecting in-context learning data 510 can include selecting one or more specialized input values (e.g., specialized tokens such as VERY_CONCISE token, structured inputs such as JSON-structured inputs, etc.) that have been used to train the machine-learned model 112 to generate aligned outputs 116. For example, in some instances, a machine-learned model 112 can be trained (e.g., fine-tuned, trained in a manner described herein with respect to FIGS. 4 or 7, etc.) using a plurality of training inputs (e.g., training inputs 414, etc.) each comprising one or more specialized tokens indicative of a dimension-specific preference. In some instances, an objective function used to train a machine-learned model 112 using training inputs comprising specialized tokens can include, for example, an objective function that rewards alignment with a preference associated with an input specialized token; penalizes misalignment with an input preference; and the like. In some instances, an objective function used to train a machine-learned model 112 using training inputs comprising specialized tokens can include an objective function similar to (e.g., same as) an objective function described above with respect to FIG. 4.

In some instances, in-context learning data 510 can include activation values (e.g., soft prompt input activations, intermediate activations, activation adjustment values, etc.) that have been determined (e.g., optimized, etc.) based on a machine learning process. For example, in some instances, a machine-learned model (e.g., machine-learned model 412, 112, etc.) can, for each of a plurality of training iterations, generate a training output based on a training input comprising a soft prompt. For each of the plurality of training iterations, a computing system can update the soft prompt based on an evaluation of an alignment of the training output with one or more dimension-specific preferences (e.g., by backpropagating an objective function, etc.). In some instances, in-context learning data 510 can include activation values (e.g., raw values, adjustment values, etc.) that have been determined based on one or more intermediate activation values generated by a machine-learned model 112 during a training process. For example, in some instances, intermediate activation values associated with a plurality of example outputs that are well aligned with a given dimension-specific preference (e.g., outputs associated with a high-magnitude orthogonal projection onto a dimension 106 associated with the preference, etc.) can be compared to intermediate activation values associated with a plurality of example outputs that are poorly aligned with the given dimension-specific preference. In some instances, one or more intermediate activation values can be identified that are shared among the aligned outputs and not among the misaligned outputs. In such instances, the identified intermediate activation values can be used as in-context learning data 510 to cause a machine-learned model 112 to generate aligned outputs 116. In some instances (e.g., in instances where an embedding space used to determine dimensions 106 is an embedding space of the machine-learned model 112 used to generate the aligned outputs 116, etc.), in-context learning data 510 can include activation values determined directly from the dimension 106. For example, in some instances, an intermediate activation (e.g., intermediate activation output by an intermediate layer that was used to generate embeddings for determining embedding dimensions 206, etc.) of a machine-learned model 112 can be adjusted in a direction that is parallel to a dimension 106 of interest to increase or decrease a magnitude of an orthogonal projection of the activation onto the dimension 106 according to an individualized dimension-specific preference.

In some instances, in-context learning data 510 can include activation value data (e.g., raw values, adjustment values, adapter layers comprising weights and activation functions for adjusting activations values, etc.) that have been trained (e.g., fine-tuned, optimized, etc.) to cause a machine-learned model 112 to generate aligned outputs 116 according to a dimension-specific preference associated with the activation value data. For example, in some instances, a plurality of machine-learned models 412 as depicted in FIG. 4 can include a plurality of machine-learned models 412 that share a plurality of foundation layers, wherein each machine-learned model 412 may have one or more adapter layers associated with one or more dimension-specific preferences. In some instances, fine-tuning each machine-learned model 412 can include fine-tuning the adapter layer(s) (e.g., according to gradient descent methods, etc.) to cause the machine-learned model 412 to generate aligned outputs 116 according to the one or more dimension-specific preferences (e.g., without updating the foundation layers for any of the machine-learned models 412, etc.). In some instances, other activation value data (e.g., soft prompt inputs, raw intermediate activation values, adjustment values, etc.) can be trained in a similar (e.g., same, etc.) manner.

In some instances, in-context learning data 510 can include other in-context learning data 510 (e.g., natural language data, etc.) that has been optimized based on one or more outputs of a machine-learned model 112. For example, in some instances, a machine-learned model 112 can be provided with one or more inputs 114 and a plurality of candidate in-context learning data 510 inputs, and can generate an output for each pair of input 114 and candidate in-context learning data 510. Each of the outputs can be compared to a dimension-specific preference (e.g., based on a magnitude of an orthogonal projection onto the dimension of an embedding of the output, etc.), and a candidate in-context learning data 510 input can be selected based on the comparisons. For example, a candidate in-context learning data 510 input having a high (e.g., highest, etc.) average alignment score over a plurality of inputs 114 can be selected based on the comparisons; stored in a data structure; and retrieved and provided to a machine-learned model 112 each time a user 328 having a similar (e.g., same) dimension-specific preference makes an inference request.

In some instances, a machine-learned model 112 provided with in-context learning data 510 can include a model that has been fine-tuned based on one or more dimension-specific preferences, or a model that has not been fine-tuned based on dimension-specific preferences. For example, in some instances, a machine-learned model 412 can be fine-tuned with respect to one or more first dimension-specific preferences, and provided with in-context learning data 510 to cause the machine-learned model 412 to generate aligned outputs 116 that are aligned with one or more second dimension-specific preferences. As another example, in some instances, a machine-learned model 112, 412 can be fine-tuned to receive in-context learning data 510 (e.g., specialized input token, structured data, or other in-context learning data, etc.), and generate aligned outputs 116 based on the in-context learning data 510. As another example, in some instances, a machine-learned model 112 can include a general-purpose pretrained model that is not fine-tuned based on in-context learning data 510 or dimension-specific preferences.

### Example Methods

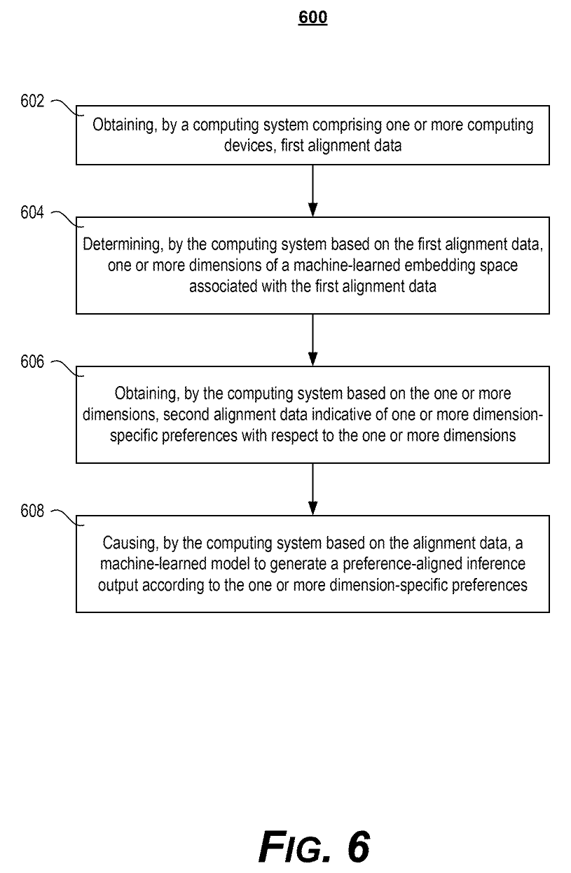

FIG. 6 depicts a flowchart diagram of an example method for generating aligned inference outputs based on dimensional analysis of alignment data according to example embodiments of the present disclosure. Although FIG. 6 depicts steps performed in a particular order for purposes of illustration and discussion, the methods of the present disclosure are not limited to the particularly illustrated order or arrangement. The various steps of example method 600 can be omitted, rearranged, combined, and/or adapted in various ways without deviating from the scope of the present disclosure.

At 602, example method 600 can include obtaining, by a computing system comprising one or more computing devices, first alignment data (e.g., first alignment data 102, etc.). In some instances, example method 600 at 602 can include using one or more systems or performing one or more activities described with respect to FIGS. 1 or 2.

At 604, example method 600 can include determining, by the computing system based on the first alignment data, one or more dimensions (e.g., dimensions 106, etc.) of a machine-learned embedding space associated with the first alignment data. In some instances, example method 600 at 604 can include using one or more systems or performing one or more activities described with respect to FIGS. 1 or 2.

At 606, example method 600 can include obtaining, by the computing system based on the one or more dimensions, second alignment data (e.g., second alignment data 110, etc.) indicative of one or more dimension-specific preferences with respect to the one or more dimensions. In some instances, example method 600 at 606 can include using one or more systems or performing one or more activities described with respect to FIGS. 1 or 3.

At 608, example method 600 can include causing, by the computing system based on the alignment data, a machine-learned model (e.g., machine-learned model 112, 412, etc.) to generate a preference-aligned inference output (e.g., aligned output 116, etc.) according to the one or more dimension-specific preferences. In some instances, example method 600 at 608 can include using one or more systems or performing one or more activities described with respect to , FIGS. 1, 4, or 5.

FIG. 7 depicts a flowchart of a method 700 for training one or more machine-learned models according to aspects of the present disclosure. For instance, an example machine-learned model can include a machine-learned model 112, 412.

One or more portion(s) of example method 700 can be implemented by a computing system that includes one or more computing devices such as, for example, computing systems described with reference to the other figures. Each respective portion of example method 700 can be performed by any (or any combination) of one or more computing devices. Moreover, one or more portion(s) of example method 700 can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of example method 700 can be performed additionally, or alternatively, by other systems.

At 702, example method 700 can include obtaining a training instance. A set of training data can include a plurality of training instances divided between multiple datasets (e.g., a training dataset, a validation dataset, or testing dataset). A training instance can be labeled or unlabeled. Although referred to in example method 700 as a “training” instance, it is to be understood that runtime inferences can form training instances when a model is trained using an evaluation of the model’s performance on that runtime instance (e.g., online training/learning). Example data types for the training instance and various tasks associated therewith are described throughout the present disclosure.

At 704, example method 700 can include processing, using one or more machine-learned models, the training instance to generate an output. The output can be directly obtained from the one or more machine-learned models or can be a downstream result of a chain of processing operations that includes an output of the one or more machine-learned models.

At 706, example method 700 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 708, example method 700 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 700 can include implementing a number of generalization techniques (e.g., weight decays, dropouts, etc.) to improve the generalization capability of the models being trained.

In some implementations, example method 700 can be implemented for training a machine-learned model from an initialized state to a fully trained state (e.g., when the model exhibits a desired performance profile, such as based on accuracy, precision, recall, etc.).

In some implementations, example method 700 can be implemented for particular stages of a training procedure. For instance, in some implementations, example method 700 can be implemented for pre-training a machine-learned model. Pre-training can include, for instance, large-scale training over potentially noisy data to achieve a broad base of performance levels across a variety of tasks/data types. In some implementations, example method 700 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 8 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, arXiv:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), chemical or biochemical data, image data, audio data, audiovisual data, haptic data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and astronomical data, sensor data and chemical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 9 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 9 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter’s toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1,7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, arXiv:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

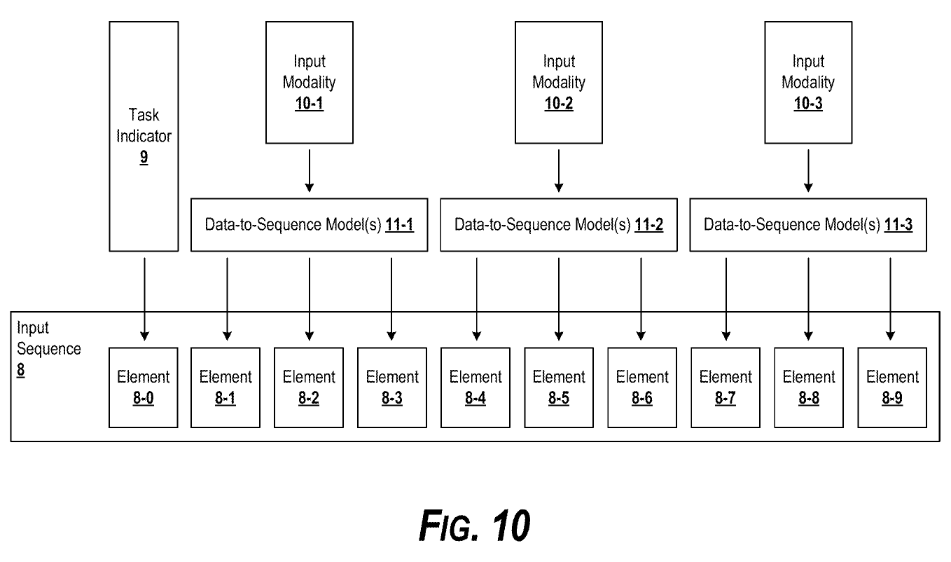

FIG. 10 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7,8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

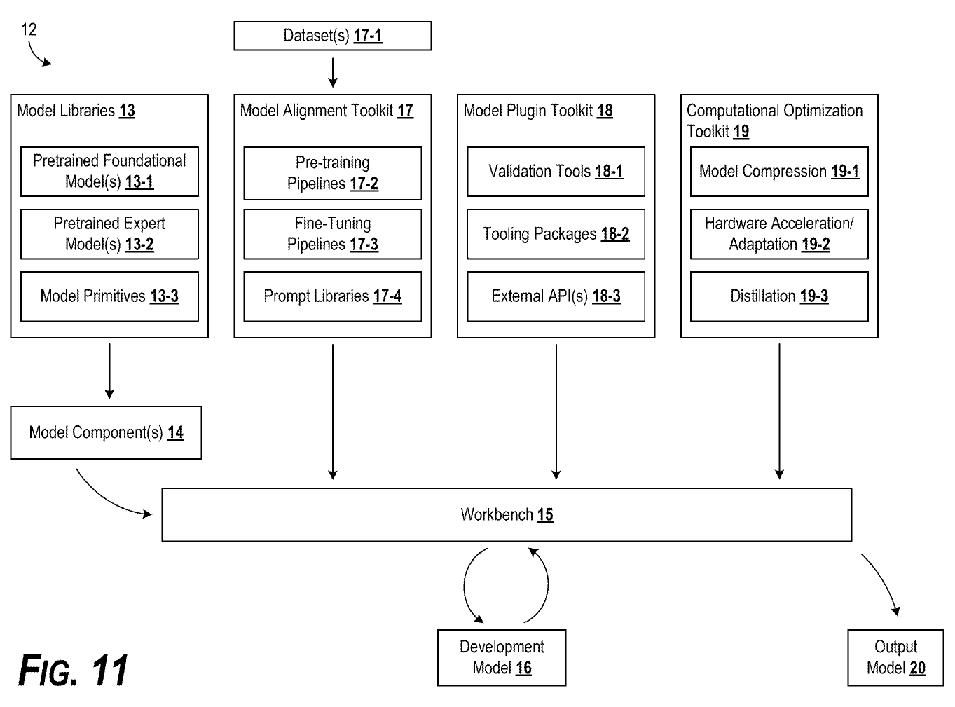

FIG. 11 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 700 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

FIG. 12 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 12 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

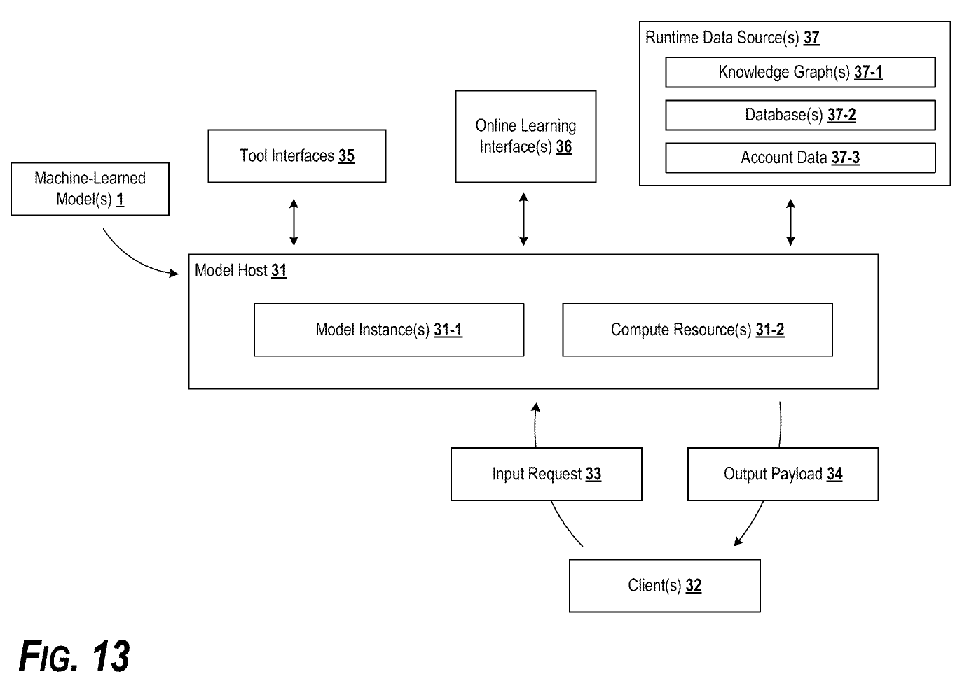

FIG. 13 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 14 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 14 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 14 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

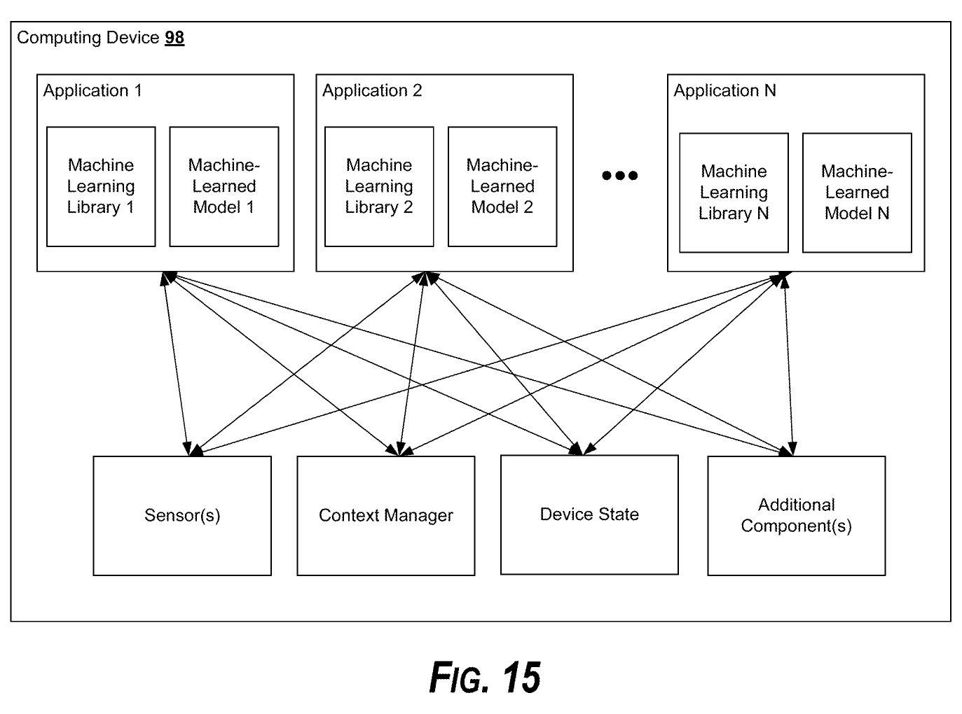

FIG. 15 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 15, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

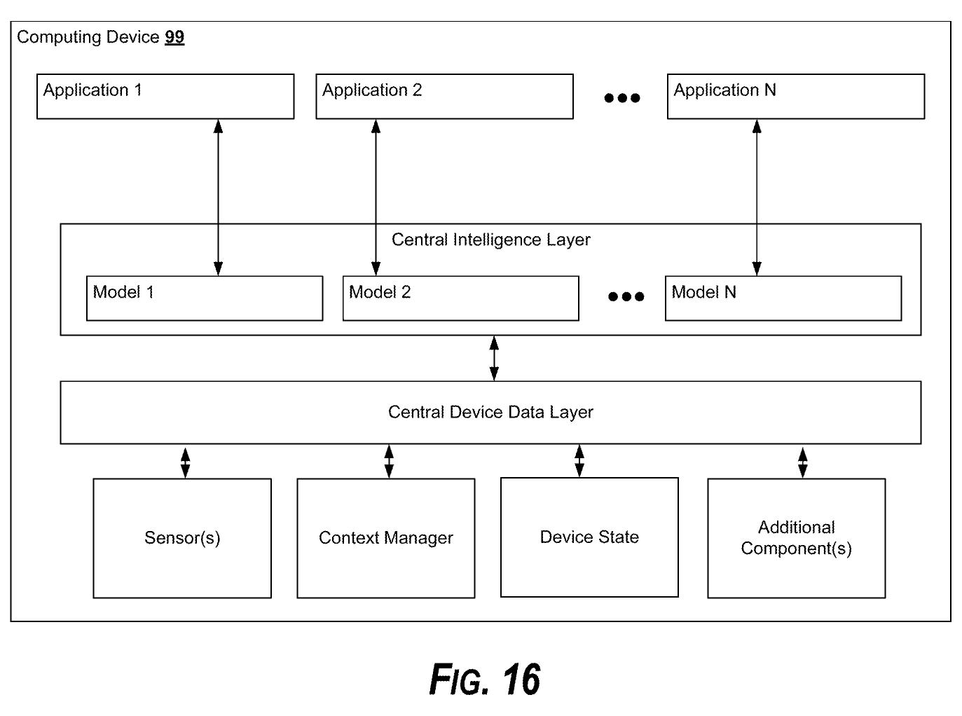

FIG. 16 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 16, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 16, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A method, comprising:
obtaining, by a computing system comprising one or more computing devices, first alignment data;
determining, by the computing system based on the first alignment data, one or more dimensions of a machine-learned embedding space associated with the first alignment data;
obtaining, by the computing system based on the one or more dimensions, second alignment data indicative of one or more dimension-specific preferences with respect to the one or more dimensions; and
causing, by the computing system based on the second alignment data, a machine-learned model to generate a preference-aligned inference output according to the one or more dimension-specific preferences.

2. The method of claim 1, wherein determining the one or more dimensions comprises principal component analysis.

3. The method of claim 1, wherein determining the one or more dimensions comprises one or more of factor analysis and independent component analysis.

4. The method of claim 1, wherein determining the one or more dimensions comprises evaluating a metric of variance associated with the first alignment data.

5. The method of claim 1, wherein determining the one or more dimensions comprises evaluating at least one of:
a metric of between-user variance of the first alignment data with respect to the one or more dimensions; and
a metric of same-user variance of the first alignment data with respect to the one or more dimensions.

6. The method of claim 1, wherein obtaining the second alignment data comprises:
outputting, by the computing system based on the one or more dimensions, a query indicative of the one or more dimensions; and
receiving, by the computing system responsive to the query, the one or more dimension-specific preferences with respect to the one or more dimensions.

7. The method of claim 6, further comprising:
providing, by the computing system based on the one or more dimensions, data indicative of the one or more dimensions to a machine-learned model; and
receiving, by the computing system from the machine-learned model, the query.

8. The method of claim 7, wherein the data indicative of the one or more dimensions comprises a data example of the first alignment data, and further comprising determining the data example based at least in part on one or more of:
a magnitude of an orthogonal projection of a machine-learned embedding of the data example onto the one or more dimensions; and
a metric of angular difference between the machine-learned embedding of the data example and the one or more dimensions.

9. The method of claim 6, wherein the query comprises a multimodal query.

10. The method of claim 9, wherein the multimodal query comprises a text component and an image component.

11. The method of claim 1, wherein causing the machine-learned model to generate a preference-aligned output comprises:
providing, by the computing system based at least in part on the second alignment data, one or more inputs to a machine-learned model that has been trained using one or more of:
third alignment data comprising a plurality of data examples indicative of the one or more dimension-specific preferences; and
an objective function configured to reward outputs that align with the one or more dimension-specific preferences and to penalize outputs that do not align with the one or more dimension-specific preferences.

12. The method of claim 11, wherein the third alignment data comprises a subset of the first alignment data, and wherein the subset was determined based on one or more of:
a plurality of magnitudes of a plurality of orthogonal projections of machine-learned embeddings associated with the first alignment data onto the one or more dimensions; and
a plurality of values of a metric of angular difference between the one or more dimensions and a plurality of machine-learned embeddings associated with the first alignment data.

13. The method of claim 1, wherein causing the machine-learned model to generate the preference-aligned inference output comprises providing, by the computing system to the machine-learned model, in-context learning content configured to align the preference-aligned inference output with the one or more dimension-specific preferences.

14. The method of claim 1, wherein causing the machine-learned model to generate the preference-aligned inference output comprises:
generating, by the computing system using one or more first layers of the machine-learned model, a first embedding based on an inference input;
generating, by the computing system based at least in part on the first embedding and based at least in part on the one or more dimension-specific preferences, a second embedding; and
processing, by one or more second layers of the machine-learned model, the second embedding to generate the preference-aligned inference output.

15. The method of claim 1, wherein the one or more dimensions comprises a plurality of dimensions, and further comprising:
receiving, by the computing system, a user input;
evaluating, by the computing system based on the user input, the plurality of dimensions to generate a plurality of evaluation scores;
selecting, by the computing system based on the plurality of evaluation scores, one or more selected dimensions for obtaining alignment data;
outputting, by the computing system based on the one or more selected dimensions, a query indicative of the one or more selected dimensions; and
receiving, by the computing system responsive to the query, the one or more dimension-specific preferences with respect to the one or more selected dimensions.

16. The method of claim 15, wherein the one or more selected dimensions are selected based at least in part on data indicative of a variance of a conditional output probability distribution of the machine-learned model with respect to the one or more selected dimensions conditioned on the user input.

17. The method of claim 1, further comprising:
clustering, by the computing system, the first alignment data by user to generate a plurality of clusters;
wherein the one or more dimensions are determined based on a first cluster of the plurality of clusters.

18. The method of claim 17, further comprising:
receiving, by the computing system, a user input from a user;
performing, by the computing system, a comparison of third alignment data associated with the user to data indicative of the plurality of clusters;
performing, by the computing system based on the comparison, a cluster assignment assigning the user to the first cluster of the plurality of clusters;
outputting, by the computing system based at least in part on the cluster assignment, a query indicative of the one or more dimensions; and
receiving, by the computing system responsive to the query, the one or more dimension-specific preferences with respect to the one or more dimensions.

19. A computing system comprising one or more processors and one or more non-transitory computer-readable media storing instructions that are executable by one or more processors to cause the computing system to perform operations, the operations comprising:
obtaining first alignment data;
determining, based on the first alignment data, one or more dimensions of a machine-learned embedding space associated with the first alignment data;
obtaining, based on the one or more dimensions, second alignment data indicative of one or more dimension-specific preferences with respect to the one or more dimensions; and
causing, based on the second alignment data, a machine-learned model to generate a preference-aligned inference output according to the one or more dimension-specific preferences.

20. The computing system of claim 19, wherein determining the one or more dimensions comprises one or more of principal component analysis, independent component analysis, and factor analysis.

21. The computing system of claim 19, wherein obtaining the second alignment data comprises:
outputting, by the computing system based on the one or more dimensions, a query indicative of the one or more dimensions; and
receiving, by the computing system responsive to the query, the one or more dimension-specific preferences with respect to the one or more dimensions.

22. One or more non-transitory computer-readable media storing instructions that are executable by one or more processors to cause a computing system to perform operations, the operations comprising:
obtaining, based on one or more dimensions of a machine-learned embedding space associated with first alignment data, second alignment data indicative of one or more dimension-specific preferences with respect to the one or more dimensions; and
causing, based on the second alignment data, a machine-learned model to generate a preference-aligned inference output according to the one or more dimension-specific preferences.
